(19) United States
(12) Patent Application Publication
(10) Pub. No.: US 2026/0244775 A1
(43) Pub. Date: Aug. 20, 2026

(54) Policy Definition and Enforcement Platform For AI-Based Access Control Systems

(71) Applicant: TEACHERS INSURANCE AND ANNUITY ASSOCIATION OF AMERICA, New York, NY (US)

(72) Inventors: Rares Ioan Almasan, Phoenix, AZ (US); Aditya Mehta, East Windsor, NJ (US); Stephen Dantu, Bedford, NY (US); Sonam Jha, Skillman, NJ (US); Sastry Vsm Durvasula, Phoenix, AZ (US); Swatee Singh, Livingston, NJ (US)

(21) Appl. No.: 19/057,794

(22) Filed: Feb. 19, 2025

(51) Int. Cl. G06F 21/62; G06N 3/045; G06N 3/0475; G06N 3/08

(52) U.S. Cl. CPC G06F 21/6218; G06N 3/045; G06N 3/0475; G06N 3/08

(57) ABSTRACT

Methods for artificial intelligence-based data access control are disclosed herein. An example computer-implemented method comprises: obtaining information management data associated with a computing environment; preprocessing the information management data to generate a set of user profiles and data asset consumption profiles for the plurality of users; generating a set of access controls for the computing environment including a set of user data access entitlements by inputting the preprocessed information management data to one or more generative artificial intelligence models; obtaining a data access request from a user; identifying a subset of the set of access controls including one or more user data access entitlements assigned to the user; applying the one or more user data access entitlements to the data access request to determine whether the data access request is valid or invalid; and in response to determining the data access request is valid, providing data access to the user.

### TECHNICAL FIELD

The present disclosure relates generally to methods and systems for artificial intelligence-based data access control, and more particularly, to techniques for implementing an artificial intelligence-based data access controller and simulating computing environments to test data access controls generated using artificial intelligence.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Traditional methods of managing access to data within organizations often rely on static, rule-based frameworks that are tightly integrated with directory services. These frameworks are not only cumbersome to manage but also become increasingly inefficient as the volume and complexity of data grows. Additionally, adapting these rigid systems to dynamic changes in data access needs/requirements, such as compliance with rapidly evolving legal and regulatory requirements, managing the risk of unauthorized access, and ensuring data quality and availability, poses significant challenges. Given these challenges, there are significant opportunities for improved data access control that addresses the problems associated with the conventional techniques.

### SUMMARY

In one aspect, a computer-implemented method artificial intelligence-based data access control includes: (1) obtaining, by one or more processors, information management data associated with a computing environment; (2) preprocessing, by the one or more processors, the information management data to generate (a) a set of user profiles corresponding to a plurality of users of the computing environment and (b) data asset consumption profiles for the plurality of users; (3) generating, by the one or more processors, a set of access controls for the computing environment including a set of user data access entitlements by inputting the preprocessed information management data to one or more generative artificial intelligence (AI) models, wherein the one or more generative AI models are trained on user profiles labelled with corresponding user data access entitlements; (4) obtaining, by the one or more processors, a data access request from a user within the plurality of users; (5) identifying, by the one or more processors, a subset of the set of access controls including one or more user data access entitlements assigned to the user; (6) applying, by the one or more processors, the one or more user data access entitlements assigned to the user to the data access request to determine whether the data access request is valid or invalid; and (7) in response to determining the data access request is valid, providing, by the one or more processors, data access to the user.

In another aspect, a computing system for artificial intelligence-based data access control includes: (1) one or more processors; and (2) one or more non-transitory memories storing computer-executable instructions thereon that, when executed by the one or more processors, cause the computing system to: (a) obtain information management data associated with a computing environment; (b) preprocess the information management data to generate (i) a set of user profiles corresponding to a plurality of users of the computing environment and (ii) data asset consumption profiles for the plurality of users; (c) generate a set of access controls for the computing environment including a set of user data access entitlements by inputting the preprocessed information management data to one or more generative artificial intelligence (AI) models, wherein the one or more generative AI models are trained on user profiles labelled with corresponding user data access entitlements; (d) obtain a data access request from a user within the plurality of users; (e) identify a subset of the set of access controls including one or more user data access entitlements assigned to the user; (f) apply the one or more user data access entitlements assigned to the user to the data access request to determine whether the data access request is valid or invalid; and (g) in response to determining the data access request is valid, provide data access to the user.

In yet another aspect, a computer-implemented method for artificial intelligence-based data access control includes: (1) obtaining, by one or more processors, contextual data for a virtual computing environment generated based on information management data for a computing environment; (2) generating, by the one or more processors, a plurality of virtual entity profiles for the virtual computing environment by inputting the contextual data to one or more generative artificial intelligence (AI) models, wherein each virtual entity profile of the plurality of virtual entity profiles includes a respective virtual data asset consumption profile; (3) generating, by the one or more processors, a virtual data infrastructure including a plurality of virtual data sources for the virtual computing environment by inputting the contextual data to the one or more generative AI models; (4) generating, by the one or more processors, a set of access controls for the virtual computing environment including a set of virtual entity data access entitlements by inputting the plurality of virtual entity profiles and the contextual data to the one or more generative AI models; (5) simulating, by the one or more generative AI models, the virtual computing environment by: (a) generating, by the one or more generative AI models, one or more virtual data access requests from one or more virtual entities of the virtual computing environment, and (b) applying, by the one or more processors, the set of access controls to the one or more virtual data access requests; (6) evaluating, by the one or more generative AI models, performance for the set of access controls based on the impact of applying the set of access controls to the one or more virtual data access requests; and (7) based on the evaluation: (a) updating, by the one or more generative AI models, the set of access controls; or (b) approving, by the one or more processors, the set of access controls for use in the computing environment.

In yet another aspect, a computing system for artificial intelligence-based data access control includes: (1) one or more processors; and (2) one or more non-transitory memories storing computer-executable instructions thereon that, when executed by the one or more processors, cause the computing system to: (a) obtain contextual data for a virtual computing environment generated based on information management data for a computing environment; (b) generate a plurality of virtual entity profiles for the virtual computing environment by inputting the contextual data to one or more generative artificial intelligence (AI) models, wherein each virtual entity profile of the plurality of virtual entity profiles includes a respective virtual data asset consumption profile; (c) generate a virtual data infrastructure including a plurality of virtual data sources for the virtual computing environment by inputting the contextual data to the one or more generative AI models; (d) generate a set of access controls for the virtual computing environment including a set of virtual entity data access entitlements by inputting the plurality of virtual entity profiles and the contextual data to the one or more generative AI models; (e) simulate, by the one or more generative AI models, the virtual computing environment by: (i) generating, by the one or more generative AI models, one or more virtual data access requests from one or more virtual entities of the virtual computing environment, and (ii) applying the set of access controls to the one or more virtual data access requests; (f) evaluate, by the one or more generative AI models, performance for the set of access controls based on the impact of applying the set of access controls to the one or more virtual data access requests; and (g) based on the evaluation: (i) update, by the one or more generative AI models, the set of access controls; or (ii) approve the set of access controls for use in the computing environment.

Advantages will become more apparent to those of ordinary skill in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The figures described below depict various aspects of the system and methods disclosed herein. It should be understood that each figure depicts an embodiment of a particular aspect of the disclosed system and methods, and that each of the figures is intended to accord with a possible embodiment thereof.

FIG. 1 depicts an example computing environment for implementing artificial intelligence-based data access control, according to some aspects.

FIG. 2 depicts a flow diagram illustrating an example computer-implemented method for artificial intelligence-based data access control, according to some aspects.

FIG. 3 depicts a flow diagram illustrating an example computer-implemented for processing data asset consumption profiles for an organizational computer network, according to some aspects.

FIG. 4 depicts a flow diagram illustrating an example computer-implemented for processing data user profiles for an organizational computer network, according to some aspects.

FIG. 5 depicts a flow diagram illustrating an example computer-implemented for processing user login and asset usage patterns for an organizational computer network, according to some aspects.

FIG. 6 depicts a flow diagram illustrating an example computer-implemented for processing access control policies for an organizational computer network, according to some aspects.

FIG. 7 depicts a flow diagram illustrating an example computer-implemented for processing risk and vulnerability reports for an organizational computer network, according to some aspects.

FIG. 8 depicts a flow diagram illustrating an example computer-implemented for processing incident context data for an organizational computer network, according to some aspects.

FIG. 9 depicts a flow diagram illustrating an example computer-implemented for processing assignment context data for an organizational computer network, according to some aspects.

FIG. 10 depicts a flow diagram illustrating an example computer-implemented for processing data privacy mandates for an organizational computer network, according to some aspects.

FIG. 11 depicts a flow diagram illustrating an example computer-implemented for processing application information for an organizational computer network, according to some aspects.

FIG. 12 depicts a flow diagram illustrating an example computer-implemented for processing external information for an organizational computer network, according to some aspects.

FIG. 13 depicts a flow diagram illustrating an example computer-implemented for generating data access controls for an organizational computer network, according to some aspects.

FIG. 14 depicts a flow diagram illustrating an example block flow diagram for various implementations of artificial intelligence-based data access control, according to some aspects.

FIG. 15 depicts an example block flow diagram for simulating a data access environment, according to some aspects.

FIG. 16 depicts an example block flow diagram for developing a finetuned language model, according to some aspects.

FIG. 17 depicts a combined block and logic diagram for training an example generative language model, according to some aspects.

FIG. 18 depicts a computer-implemented method for artificial intelligence-based data access control, according to some aspects.

FIG. 19 depicts a computer-implemented method for artificial intelligence-based data access control, according to some aspects.

### DETAILED DESCRIPTION

### Overview

Traditional methods of managing access to data within organizations often rely on static, rule-based frameworks that are tightly integrated with directory services. These frameworks are not only cumbersome to manage but also become increasingly inefficient as the volume and complexity of data grows. Additionally, adapting these rigid systems to dynamic changes in data access needs/requirements poses significant challenges, such as compliance with rapidly evolving legal and regulatory requirements, managing the risk of unauthorized access, and ensuring data quality and availability. Given these challenges, there are significant opportunities for improved data access control that addresses the problems associated with the conventional techniques.

In the rapidly evolving landscape of technology, organizations are tasked with the continuous challenge of seamlessly updating and managing their technological infrastructure in response to dynamic changes in data access needs and requirements without imparting undue constraints on the organizations'data access environment. For example, organizations often encounter the significant hurdle of technical debt, which includes issues such as suboptimal design, outdated code, inadequate infrastructure, security vulnerabilities, and inefficient data management. As mentioned above, conventional methods of managing data access often rely on static and/or rule-based frameworks that are difficult to adapt to changes in data access needs/requirements. Further, the reliance on outdated access control mechanisms often leads to various data security and data management issues (e.g., particularly in response to updating/changing data access controls), such as role explosions, where the number of roles (e.g., entity entitlements) increases to an unmanageable extent, and transitive trust issues, where granting access to one resource inadvertently grants access to additional resources. However, achieving a balance between meeting changing data access needs/requirements and maintaining the performance and efficiency of existing data access infrastructures poses significant challenges to organizations. Further, failing to achieve a balance between these two objectives not only hinders the productivity of development teams but also poses significant risks such as system failures, security breaches, and disruptions, adversely affecting business operations and end-user experiences. Traditionally, the manual assessment of data access infrastructures has been a complex, expensive, and time-consuming process, consuming a significant portion of technology budgets and professional time.

Addressing these challenges, the disclosed system and model(s) present a novel approach to assess, update, and improve data access controls for a computing network, as well as adherence to data access needs and requirements for the computing network. This approach, powered by artificial intelligence (AI), leverages the ability to access existing data asset consumption profiles, user asset usage patterns, access control policies, and other information management data of a computing network to generate AI-based data access controls for the computing network that can be seamlessly updated without introducing new data security and data management issues. By preprocessing current information management data for a computing network and updating/generating data access controls for the computing network (e.g., on deterministic or probabilistic basis, on a heuristic basis, in response to a detected issue, etc.), the system advantageously offers responsive and flexible data access controls.

The general inventive scope of the claims encompasses a computing system and methods for artificial intelligence-based data access control. This system employs one or more processors and memories to obtain data, preprocess data to generate input data, generate data access controls based on the input data, and implement the data access controls. These data access controls may be generated by inputting the preprocessed data to one or more generative AI models trained on user profiles labelled with corresponding user data access entitlements, provides securely generated data access controls tailored to an organization specific needs, requirements, and permissions.

The aspects of the claims result in a practical application that effectively solves the prior art problems by dynamically generating and updating data access controls based on compliance and security requirements as well as entity specific behavior and data access patterns, thereby improving over the static and/or rule-based frameworks of the conventional techniques. Further, an example system may analyze and predict entity access needs and potential security vulnerabilities in real-time. This predictive capability allows organizations to proactively manage data security and compliance with access policies.

Another significant improvement is the optimization of network usage. The system's ability to remotely access and analyze data from various platforms, monitoring systems, management tools, data sources, and/or applications minimizes the need for extensive data transfers, thereby reducing network load. This efficient use of network resources is particularly beneficial for organizations with distributed teams and cloud-based infrastructures, ensuring that the generation of AI-based data access controls does not disrupt other operations.

Additionally, example systems and methods include simulating a virtual data access environment to test and validate AI-based data access controls. By preprocessing information management data for an organization (e.g., as described above) an example system can generate a virtual computing environment that mirrors the real-world computing environment of an organization, including its entities, data access patterns, entity behaviors, compliance requirements, and potential security vulnerabilities. Further, by leveraging generative AI models to simulate data access requests and apply AI-generated access controls, the system can evaluate the effectiveness of these AI-based data access controls in real-time. This simulation and evaluation process not only identifies potential weaknesses in the generated access control system/policies but also provides a basis for continuous improvement. The ability to simulate and test access controls in a virtual environment before implementation ensures that the actual computing environment is not adversely affected by untested or suboptimal access control policies. This proactive approach to data access management represents a significant advancement over traditional, static methods, offering organizations the flexibility to adapt to changing data access needs and security threats without compromising the integrity or performance of their computing networks.

Furthermore, the system introduces improvements in memory usage which further enhances its practical application, ensuring intelligent data processing and storage mechanisms. By selectively processing relevant data and efficiently storing the results of generating and/or implementing AI-based access controls, the system minimizes the memory footprint required for its operation. This efficient memory usage enables maintaining high performance and scalability without disrupting other operations. Through these improvements, the disclosed system(s) and method(s) offer solutions to the challenges of managing data access control and security, enabling organizations to maintain a competitive edge in the rapidly changing technological landscape, especially in environments with limited computing resources.

These challenges highlight the need for a more flexible, efficient, and secure approach to data access control that can efficiently adapt to the changing landscape of data management and security requirements.

As used herein, the term “data asset” may refer to any potentially accessible digital information/data, or resource of an organization, such as a file, document, database, etc.

As used herein, the term “access controls” may refer to mechanisms policies, and procedures implemented (e.g., via code and/or instructions stored in a memory) to regulate who or what can view or access data and other resources within a computing environment, including the management of user permissions and data access rights.

As used herein, the term “information management data” may refer to data from various platforms, monitoring systems, management tools, data sources, and/or applications of a computing environment/network, including entity data (e.g., data asset consumption profiles, user asset usage patterns), policies (e.g., access control policies), metadata, logs, procedures for data lifecycle management, etc.

As used herein, the term “data access requests” may refer to formal or informal petitions made by users, systems, or processes to retrieve, modify, or interact with data assets within a computing environment, subject to evaluation against established access controls and entitlements.

As used herein, the term “data access environment” may refer to the collective hardware, software, policies, and procedures that define how data is stored, accessed, and managed within an organization, including the security measures and access controls in place.

As used herein, the term “data infrastructure” may refer to the underlying physical and virtual resources, including hardware, software, networks, and facilities, that support the storage, processing, and management of data within an organization.

### Example Computing Environment

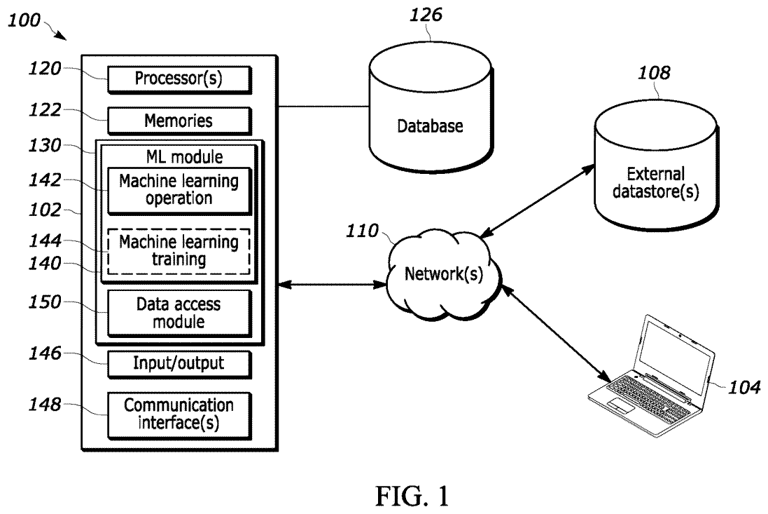

FIG. 1 illustrates an example computing environment 100 associated with generating data access controls for an organizational computer network. Although FIG. 1 depicts certain entities, components, equipment, and devices, it should be appreciated that additional or alternate entities, components, equipment, and devices are envisioned.

The computing environment 100 may include a server computing device 102, one or more user computing devices 104, and one or more external datastores 108. The server computing device 102, user computing device(s) 104, and external datastore 108 may be communicatively coupled via an electronic network 110.

As shown in FIG. 1, the environment 100 may include user computing device(s) 104 associated with an organizational computer network. For example, the organizational computer network may be associated with an organization, or some other entity, interested in managing a network of computing devices/elements. For ease of reading herein (and not for limitation purposes), the organizational computer network may be referred to using the singular tense, however the environment 100 may include user computing devices associated with various organization computer networks and the server computing device 102 may implement AI-based data access controls as described herein for each of the various organizational computer networks. The one or more user computing devices 104 may be any suitable device, including one or more computers, mobile devices, wearables, smart watches, smart glasses, augmented and/or virtual reality (e.g., augmented reality, virtual reality, extended reality, mixed reality, etc.) glasses or headsets, and/or other electronic or electrical components. The user computing devices 104 may include a memory and a processor for, respectively, storing and executing one or more modules. The memory may include one or more suitable storage media such as a magnetic storage device, a solid-state drive, random access memory (RAM), etc. The one or more user computing devices 104 may communicate with and/or access services or other components of the computing environment 100 via the network 110. For ease of reading herein (and not for limitation purposes), the one or more user computing devices 104 may be referred to using the singular tense.

In one aspect, server computing device 102 may perform functionalities as part of a cloud network or may otherwise communicate with other hardware or software components within one or more cloud computing environments to send, retrieve, or otherwise analyze data or information described herein. For instance, in certain aspects of the present techniques, the computing environment 100 may comprise an on-premise computing environment, a multi-cloud computing environment, a public cloud computing environment, a private cloud computing environment, and/or a hybrid cloud computing environment. For example, an entity (e.g., an organization) managing an organizational computer network may host one or more services in a public cloud computing environment (e.g., Alibaba Cloud, Amazon Web Services (AWS), Google Cloud, IBM Cloud, Microsoft Azure, etc.). The public cloud computing environment may be a traditional off-premise cloud (i.e., not physically hosted at a location owned/controlled by the organization). Alternatively, or in addition, aspects of the public cloud may be hosted on-premise at a location owned/controlled by the entity managing the organizational computer network. The public cloud may be partitioned using virtualization and multi-tenancy techniques and may include one or more infrastructure-as-a-service (IaaS) and/or platform-as-a-service (PaaS) services.

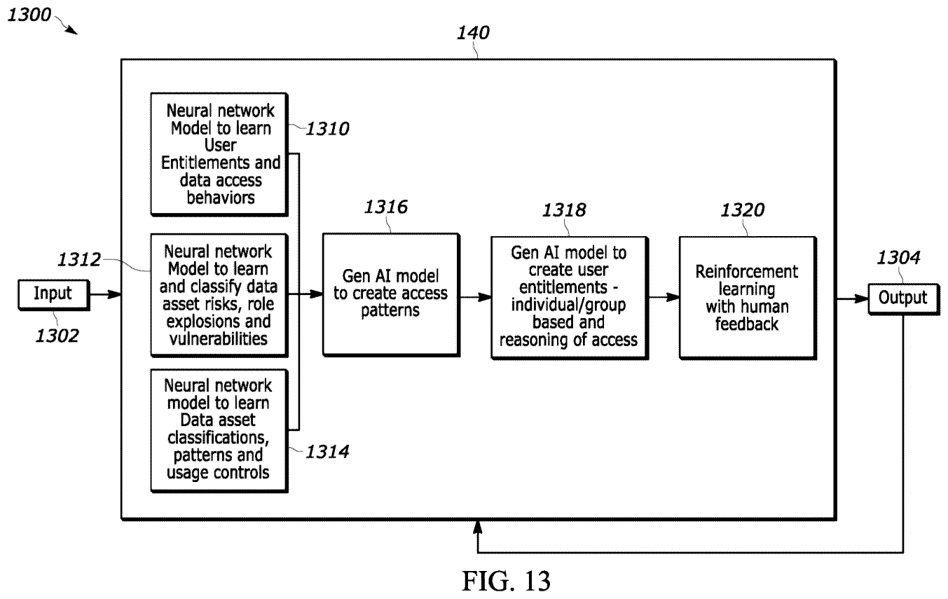

The one or more external datastore(s) 108 may be relational databases, such as Oracle, DB2, MySQL, NoSQL-based databases, such as MongoDB, a web-based data repository, such as Elasticsearch, or another suitable datastore. In some embodiments, the external datastore 108 may store information technology (IT) data and/or resources suitable for training one or more machine learning (ML) models as described herein (e.g., with respect to the ML module 140, FIGS. 13-18, and/or the methods/flowcharts of this disclosure). Additionally or alternatively, the external datastore(s) 108 may store additional data (e.g., the information management data described herein) that is used to train and/or operate one or more ML models, simulate computing environments, among other things. For ease of reading herein (and not for limitation purposes), the one or more external datastores 108 may be referred to using the singular tense.

One or more networks 110 may comprise any suitable network or networks, including a local area network (LAN), wide area network (WAN), the Internet, or a combination thereof. For example, network(s) 110 may include a wireless cellular service (e.g., 4G, 5G, 6G, etc.). Generally, the network 110 enables bidirectional communication between the server computing device 102, user device 104, and external datastore(s) 108. Additionally or alternatively, the network 110 may comprise one or more routers, wireless switches, or other such wireless connection points communicating to the components of the computing environment 100 via wireless communications based upon any one or more of various wireless standards, including by non-limiting example, IEEE 802.11a/b/c/g (Wi-Fi), Bluetooth, and/or the like. For ease of reading herein (and not for limitation purposes), the one or more networks 106 may be referred to using the singular tense.

The server computing device 102 may include one or more processors 120. The processors 120 may include one or more suitable processors (e.g., central processing units (CPUs) and/or graphics processing units (GPUs)). The processors 120 may be connected to a memory 122 via a computer bus (not depicted) responsible for transmitting electronic data, data packets, or otherwise electronic signals to and from the processors 120 and memory 122 in order to implement or perform the machine-readable instructions, methods, processes, elements, or limitations, as illustrated, depicted, or described for the various flowcharts, illustrations, diagrams, figures, and/or other disclosure herein. The processors 120 may interface with the memory 122 via a computer bus to execute an operating system (OS) and/or computing instructions contained therein, and/or to access other services/aspects. For example, the processors 120 may interface with the memory 122 via the computer bus to create, read, update, delete, or otherwise access or interact with the data stored in the memory 122 and/or a database 126. In some embodiments, the computing environment 100 may include multiple server computing devices respectively configured to perform at least a portion of the techniques described herein. For ease of reading herein (and not for limitation purposes) the server computing device 102 may be referred to using the singular tense.

The memory 122 may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others. The memory 122 may store an operating system (OS) (e.g., Microsoft Windows, Linux, UNIX, etc.) capable of facilitating the functionalities, apps, methods, or other software as discussed herein.

The memory 122 may store a plurality of computing modules 130, implemented as respective sets of computer-executable instructions (e.g., one or more source code libraries, trained ML models such as neural networks, convolutional neural networks, etc.) as described herein.

In general, a computer program or computer-based product, application, or code (e.g., the model(s), such as ML models, or other computing instructions described herein) may be stored on a computer usable storage medium, or tangible, non-transitory computer-readable medium (e.g., standard random access memory (RAM), an optical disc, a universal serial bus (USB) drive, or the like) having such computer-readable program code or computer instructions embodied therein, wherein the computer-readable program code or computer instructions may be installed on or otherwise adapted to be executed by the processor(s) 120 (e.g., working in connection with the respective operating system in memory 122) to facilitate, implement, or perform the machine-readable instructions, methods, processes, elements, or limitations, as illustrated, depicted, or described for the various flowcharts, illustrations, diagrams, figures, and/or other disclosure herein. In this regard, the program code may be implemented in any desired program language, and may be implemented as machine code, assembly code, byte code, interpretable source code, or the like (e.g., via Golang, Python, C, C++, C#, Objective-C, Java, Scala, ActionScript, JavaScript, HTML, CSS, XML, etc.).

The database 126 may be a relational database, such as Oracle, DB2, MySQL, a NoSQL-based database, such as MongoDB, or another suitable database. The database 126 may store data that is used to train and/or operate one or more ML models, simulate computing environments, among other things.

In one aspect, the computing modules 130 may include an ML module 140. The ML module 140 may include an ML operation module (MLOM) 142 and/or an ML training module (MLTM) 144. In some embodiments, at least one of a plurality of ML methods and algorithms may be applied by the ML module 140, which may include, but are not limited to: linear or logistic regression, instance-based algorithms, regularization algorithms, decision trees, Bayesian networks, cluster analysis, association rule learning, artificial neural networks, deep learning, combined learning, reinforced learning, dimensionality reduction, and support vector machines. In various embodiments, the implemented ML methods and algorithms are directed toward at least one of a plurality of categorizations of ML, such as supervised learning, unsupervised learning, and reinforcement learning.

In one aspect, the ML-based algorithms may be included as a library or package executed on server computing device 102. For example, libraries may include the TensorFlow-based library, the HuggingFace library, the PyTorch library, and/or the scikit-learn Python library.

In one embodiment, the ML module 140 employs supervised learning, which involves identifying patterns in existing data to make predictions about subsequently received data. Specifically, the ML module is “trained” (e.g., via MLTM 144) using training data, which includes example inputs and associated example outputs. Based upon the training data, the ML module 140 may generate a predictive function that maps outputs to inputs and may utilize the predictive function to generate ML outputs based upon data inputs. The exemplary inputs and exemplary outputs of the training data may include any of the data inputs or ML outputs described above. In the exemplary embodiments, a processing element may be trained by providing it with a large sample of data with known characteristics or features.

In another embodiment, the ML module 140 may employ unsupervised learning, which involves finding meaningful relationships in unorganized data. Unlike supervised learning, unsupervised learning does not involve user-initiated training based upon example inputs with associated outputs. Rather, in unsupervised learning, the ML module 140 may organize unlabeled data according to a relationship determined by at least one ML method/algorithm employed by the ML module 140. Unorganized data may include any combination of data inputs and/or ML outputs as described above.

In yet another embodiment, the ML module 140 may employ reinforcement learning, which involves optimizing outputs based upon feedback from a reward signal. Specifically, the ML module 140 may receive a user-defined reward signal definition, receive a data input, utilize a decision-making model to generate the ML output based upon the data input, receive a reward signal based upon the reward signal definition and the ML output, and alter the decision-making model so as to receive a stronger reward signal for subsequently generated ML outputs. Other types of ML may also be employed, including deep or combined learning techniques.

The MLTM 144 may receive labeled data at an input layer of a model having a networked layer architecture (e.g., an artificial neural network, a convolutional neural network, etc.) for training the one or more ML models. The received data may be propagated through one or more connected deep layers of the ML model to establish weights of one or more nodes, or neurons, of the respective layers. Initially, the weights may be initialized to random values, and one or more suitable activation functions may be chosen for the training process. The present techniques may include training a respective output layer of the one or more ML models. The output layer may be trained to output a prediction, for example.

The MLOM 142 may comprise a set of computer-executable instructions implementing ML loading, configuration, initialization, and/or operation functionality. The MLOM 142 may include instructions for storing trained models (e.g., in the electronic database 126). As discussed, once trained, the one or more trained ML models may be operated in inference mode, whereupon when provided with de novo input that the model has not previously been provided, the model may output one or more predictions, classifications, etc., as described herein.

In one aspect, the computing modules 130 may include an input/output (I/O) module 146, comprising a set of computer-executable instructions implementing communication functions. The I/O module 146 may include a communication component configured to communicate (e.g., send and receive) data via one or more external/network port(s) to one or more networks or local terminals, such as the network 110 and/or the one or more user devices 104 (for rendering or visualizing) described herein. In one aspect, the server computing device 102 may include a client-server platform technology such as ASP. NET, Java J2EE, Ruby on Rails, Node.js, a web service or online API, responsible for receiving and responding to electronic requests.

I/O module 146 may further include or implement an operator interface configured to present information to an administrator or operator and/or receive inputs from the administrator and/or operator. An operator interface may provide a display screen. The I/O module 146 may facilitate I/O components (e.g., ports, capacitive or resistive touch-sensitive input panels, keys, buttons, lights, LEDs), which may be directly accessible via, or attached to, server computing device 102 or may be indirectly accessible via or attached to the one or more user devices 104. In some aspects, an administrator or operator may access the server computing device 102 via an administrator device (not depicted) and/or via the one or more user devices 104 to review information, make changes, input training data, initiate training via the MLTM 144, and/or perform other functions (e.g., operation of one or more trained models via the MLOM 142).

In some embodiments, the data access module 150 discussed herein may be configured to utilize AI and/or ML techniques. The data access module 150 may employ supervised or unsupervised ML techniques, which may be followed by, and/or used in conjunction with, reinforced or reinforcement learning techniques. The data access module 150 may employ the techniques utilized for ChatGPT or Google Bard.

Noted above, in some embodiments, a data access module 150 may be configured to implement ML, such that server computing device 102 “learns” to analyze, organize, and/or process data without being explicitly programmed.

In one embodiment, the computing environment 100 may generate data access controls for organizational computer networks and/or virtual computing environments. In one aspect, the one or more user devices 104 may transmit information management data associated with an organizational computer network and/or various data access tools and data sources to the server computing device 102. For example, the one or more user devices 104 may transmit to the server computing device 102, data from data management tools, people management platforms, machine generated logs, policy management tools, security management tools, risk and legal tools, etc. The server computing device 102 may cause data access module 150 to process the information management data to generate data access controls for the organizational computer network, which may include various data access entitlements for entities of the organizational computer network. The server computing device 102 may provide or deny access to users of the organizational computer network, and/or corresponding user computing devices 104 via network 110, in response to applying at least a subset of the generated data access controls to data access requests from the users (e.g., providing access when a data access request is valid and denying access when a data access request is invalid).

The computing environment 100 may include additional, fewer, and/or alternate components, and may be configured to perform additional, fewer, or alternate actions, including components/actions described herein. Although the computing environment 100 is shown in FIG. 1 as including one instance of various components such as server computing device 102, user computing device 104, external datastore 108, network 110, etc., various aspects include the computing environment 100 implementing any suitable number of any of the components shown in FIG. 1 and/or omitting any suitable ones of the components shown in FIG. 1. For instance, information described as being stored at server database 126 may be stored at memory 122 and/or external datastore 108, and thus database 126 may be omitted. Moreover, various aspects include the computing environment 100 including any suitable additional component(s) not shown in FIG. 1, such as but not limited to the exemplary components described herein. Furthermore, it should be appreciated that additional and/or alternative connections between components shown in FIG. 1 may be implemented. As just one example, server computing device 102 and user computing device(s) 104 may be connected via a direct communication link (not shown in FIG. 1) instead of, or in addition to, via network 110.

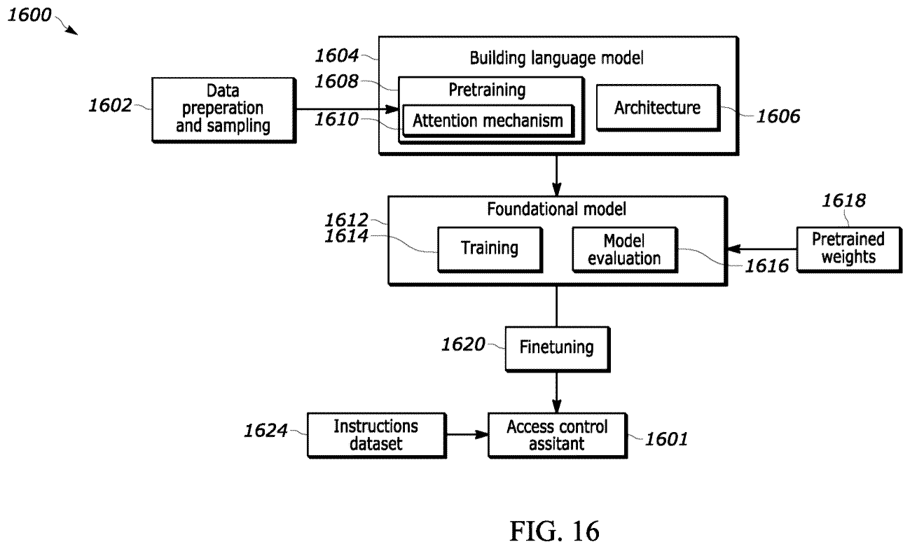

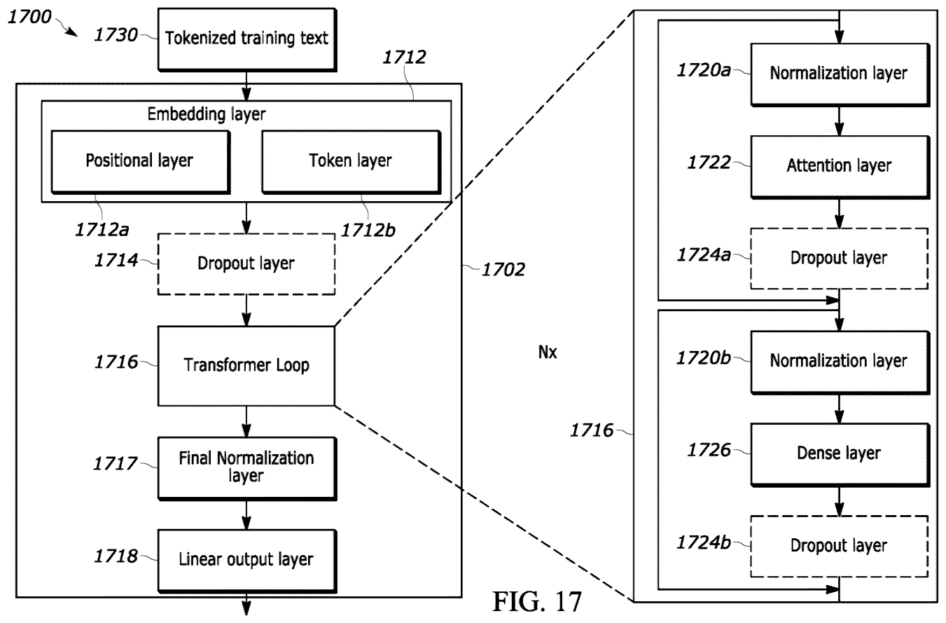

In operation, the computing environment 100 functions to improve data access control for dynamic computing environments using an AI-based data access control system. A user or entity, such as a member of an organization or an application executing in a computing environment with data access capabilities, may generate various data access requests within an organizational computer network. An example system analyzes information management data for the organizational computer network and generates data access controls based on the information management data using various machine learning models and/or generative artificial intelligence (AI) models. Techniques for training and/or implementing example generative AI model(s) are described in more detail below with reference to FIGS. 16-17. Advantageously, an example system constructs data asset consumption profiles and identifies existing data access entitlements based on the information management data. Then the system generates a set of data access controls based on the data asset consumption profiles and data access entitlements. Moreover, the system can generate and/or update data access controls responsive to dynamic changes in data access requirements for an organizational computer network. Furthermore, an example system may generate data access controls based on additional data requirements (e.g., security requirements, regulatory requirements, risk requirements, etc.) thereby ensuring that the generated data access controls accurately reflect entity-based access requirements (e.g., based on consumption profiles and/or entitlements) and system-based access requirements (e.g., based on security requirements, regulatory requirements, risk requirements, etc.).

As used herein, the term “data asset consumption profiles” may refer to detailed records or patterns of how data assets are accessed, utilized, and/or interacted with by entities (e.g., users, applications, systems, etc.) of a computing environment/network, highlighting usage trends and potential areas for optimization.

As used herein, the term “data access entitlements” may refer to the rights and permissions granted to various individual entities or groups of entities that define the scope of access to specific data assets within a computing environment, including what actions they are allowed to perform on the data.

As used herein, the term “entity profiles” may refer to comprehensive descriptions of users, systems, or devices within a computing environment, detailing their characteristics, roles, permissions, and behaviors in relation to data access and usage.

As used herein, the term “data access patterns” may refer to the recurring methods, behaviors, or trends observed in how data is requested, accessed, and used within a computing environment, often informing the development of access controls and security policies.

Further, the example computing environment 100 allows an organization to implement dynamic data access controls responsive to continuously evolving data access requirements. By leveraging machine learning models and generative AI models, an example system can efficiently generate and/or update data access controls based on a wide variety of data access considerations, thereby improving security for computing systems and improving the overall efficiency of data access and exchange within an organizational computer network. Accordingly, the techniques described herein with respect to AI-based data access control represent a significant improvement over conventional data access techniques at least by reducing the computational load and storage requirements of conventional data access systems through improved data access efficiency.

### Example Computer-Implemented Methods

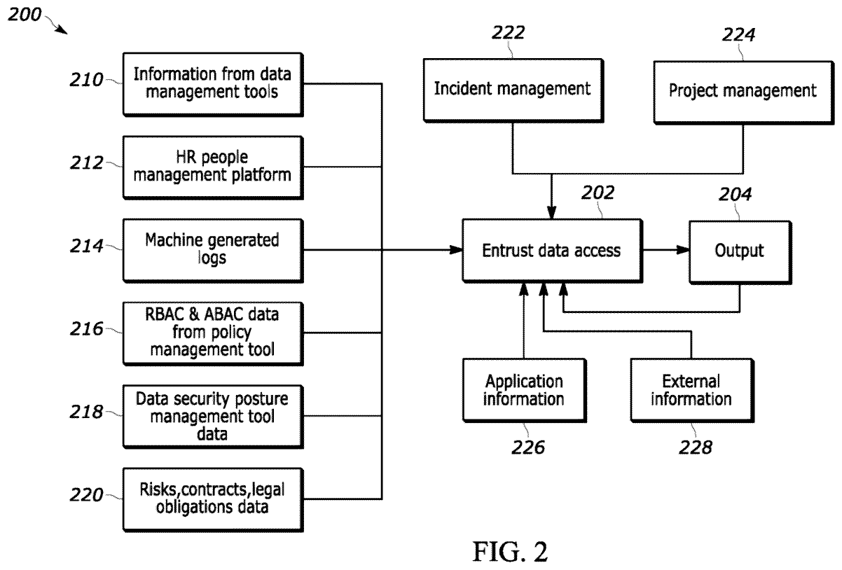

FIG. 2 depicts a computer-implemented method 200 for AI-based data access control. This method is designed to assess data access controls and/or data access environments, including entities, software and hardware platforms, tools, and processes, and to generate data access controls representative of dynamic changes to data access needs and requirements. The method 200 may be performed by the components of FIG. 1 (e.g., the environment 100) as discussed above.

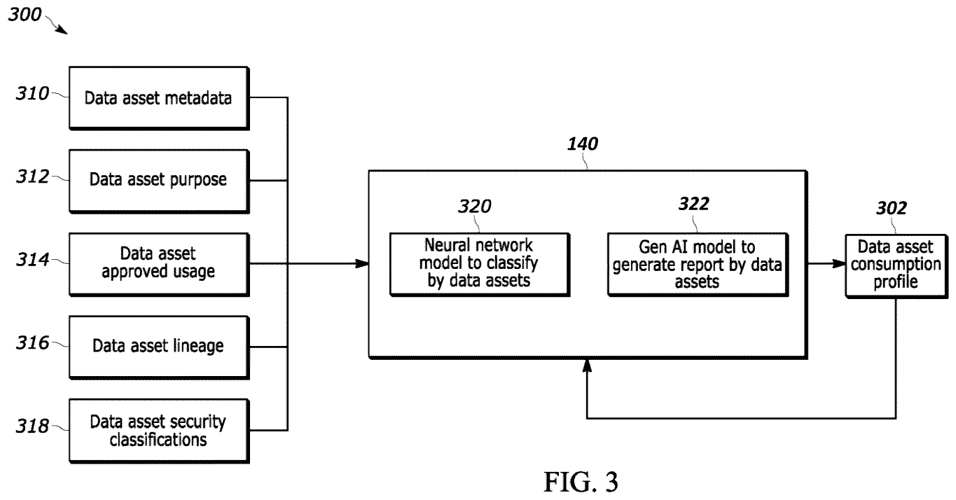

Generally, one or more steps of the method 200 may include utilizing and/or implementing one or more machine learning models (e.g., via ML module 140 of FIG. 1) to analyze/process data of an organizational computer network, as described further below with respect to FIGS. 3-13.

The method 200 may include collecting information from one or more data management tools (block 210). This step involves aggregating and analyzing data related to managing data assets of the organizational computer network (e.g., data classifications, information related to data lifecycle management, data quality metrics, etc.). The information collected at block 210 informs the machine learning models discussed herein (e.g., one or more generative AI models, one or more neural networks, and/or one or more additional machine learning models) at a high level, providing an understanding of the current state of data management and identifying potential areas for applying more granular or dynamic access controls.

The method 200 may include collecting information and/or data from one or more entity management platforms (block 212). This step involves aggregating and analyzing data on entity roles, responsibilities, and organizational hierarchy. For example, an entity may be a user, an employee of an organization, an administrator of an organization, etc. The information collected at block 212 defines role-based access controls (RBAC) for the machine learning models and provides the context in which users interact with data, thereby enabling the creation of more nuanced access control policies that reflect the actual data access needs of different user groups within the organization.

The method 200 may include receiving machine generated logs (block 214). This step involves obtaining logs that provide insights into entity activities (e.g., user activities, application activities, etc.), data access patterns, and system events. By analyzing the machine generated logs, the machine learning models are able to identify normal and anomalous data access behaviors, thereby enabling the models to detect potential security threats and refine access controls based on actual usage patterns.

The method 200 may include determining role-based access controls (RBAC) and attribute-based access controls (ABAC) based on data from one or more policy management tools (block 216). This step involves analyzing existing access control policies to identify how roles and attributes are currently used to govern data access in the organizational computer network. By analyzing existing RBAC and ABAC, the machine learning models can identify gaps in the existing access control framework and generate more effective and flexible access control mechanisms that can adapt to changing data needs.

The method 200 may include determining data security posture based on data from one or more security management tools (block 218). This step involves analyzing current data security measures (e.g., encryption standards, data loss prevention strategies, vulnerability management practices, etc.). Analyzing the current data security measures enables the machine learning models to align the generated data access controls with the overall data security strategy of the organizational computer network.

The method 200 may include determining risks, contracts, and legal obligations based on data from one or more risk management platforms/data sources (block 220). This step involves analyzing the legal, contractual, and risk-related constraints on data access within the organizational computer network. By understanding these constraints, the machine learning models can generate access controls that are compliant with regulatory requirements and contractual obligations, and also mitigate identified risks.

The method 200 may include collecting incident management data (block 222). This step involves aggregating and analyzing data related to past security incidents, breaches, and data access anomalies. By analyzing such incident management data, the machine learning models can identify patterns and vulnerabilities to be addressed through improved access controls, thereby enabling the organizational computer network to prevent and efficiently respond to security incidents.

The method 200 may include collecting project management data (block 224). This step involves aggregating and analyzing information on ongoing and planned projects, including project-specific data access requirements. By analyzing the project management data, the machine learning models can generate access controls flexible enough to support dynamic data access needs of different projects without compromising data security.

The method 200 may include collecting application information (block 226). This step involves aggregating and analyzing data related to applications executing within the organizational computer network, including data access and processing activities of the applications. By analyzing the application information, the machine learning models can generate access controls compatible with the applications' data requirements that do not inadvertently restrict necessary data flows.

The method 200 may include collecting external information (block 228). This step involves aggregating and analyzing data from external sources, such as industry benchmarks, threat intelligence feeds, and regulatory updates. By analyzing the external information, the machine learning models can generate access controls informed by the latest external insights and best practices, thereby enhancing the data security posture of the organizational computer network.

The method 200 may include evaluating the data, information, machine generated logs, risks, contracts, and legal obligations, to generate data access controls for the organizational computer network and entrusting data access for various entities of the organizational computer network (block 202). For example, the method 200 may include applying the generated access controls to various data access requests, each corresponding to a respective entity of the organizational computer network. This step may involve analyzing the collected data and information (e.g., as described above with respect to blocks 210-228) to identify patterns, risks, and requirements that inform the generation of dynamic access controls responsive to changes in data access needs and requirements. By applying portions, or subsets, of the generated access controls (e.g., a subset of access controls associated with a particular entity) to data access requests within the organizational computer network, various logs and reports are automatically generated to document each data access attempt/request. Further, the method 200 may include dynamically adjusting access controls in real-time (e.g., in response to changes to one or more data access entitlements).

The method 200 may include generating feedback data and/or output data based on the logs and reports generated in response to the organizational computer network entrusting data access (block 204). This step may involve monitoring the effectiveness of the applied access controls and generating performance reports for the access controls, for example, based on access patterns, policy violations, and compliance status. In some embodiments, the method 200 may include continuously refining and updating the access controls based on the feedback/output data, thereby ensuring the access controls remain aligned with evolving data access needs/requirements.

As used herein, the term “data access metrics” may refer to quantitative measures and statistics that provide insights into the nature, frequency, and outcomes of data access attempts within a computing environment, aiding in the evaluation of access control effectiveness and data security.

As used herein, the term “data asset risk metric” may refer to a quantifiable measure that evaluates the potential risk associated with accessing or using a specific data asset, considering factors such as sensitivity, compliance requirements, and vulnerability to unauthorized access.

As used herein, the term “data asset role explosion metric” may refer to a measure that quantifies the complexity and proliferation of user roles and permissions associated with a data asset, highlighting potential issues with role management and access control scalability.

As used herein, the term “data asset vulnerability metric” may refer to a quantifiable evaluation of the susceptibility of a data asset to security threats and breaches, taking into account factors such as known vulnerabilities, security controls in place, and the asset's value to the organization.

FIG. 3 illustrates a flow diagram representing a computer-implemented method 300 for generating data asset consumption profiles for an organizational computer network, according to some aspects. The method 300 includes processing data related to various data management tools, including data asset information such as metadata, asset purposes, approved usages, lineages, and security classifications, and utilizing machine learning models (e.g., via ML module 140 of FIG. 1) to classify the data asset information and subsequently generate one or more data asset consumption profiles. The method 300 may include collecting data asset information from various data sources within the organizational computer network (blocks 310, 312, 314, 316, 318). This step involves analyzing and aggregating data asset metadata (310), data asset purposes (312), data asset approved usages (314), data asset lineages (316), and data asset security classifications (318), which together provide a comprehensive view of data asset consumption within the organizational computer network. The method 300 may include applying a neural network model to classify the collected data/information by data assets (block 320), as discussed with respect to FIG. 1, above. For example, the method 300 may include sorting and categorizing the data asset information, using the neural network(s) based on data asset types, characteristics, and relevance. The method 300 may include generating a report for the data asset information associated with the organizational computer network by leveraging a generative artificial intelligence (AI) model (block 322). For example, the method 300 may include feeding the classified data into a generative AI model equipped with natural language processing capabilities that is configured to (e.g., by instruction included in a prompt provided to the generative AI model) process and synthesize the classified data to create a detailed report. In some embodiments, the method 300 may include generating one or more data asset consumption profiles using the generative AI model(s) and based on the classified data from the neural network(s). Techniques for training the generative AI model(s) are described in more detail below with reference to FIGS. 16-17. Further, the method 300 may include providing the data asset consumption profiles (block 302) as an output (e.g., to be presented to a user for review). In some embodiments, the method 300 may include processing the generated data asset consumption profiles (e.g., via ML module 140), to further refine the contextual information associated with data assets of the organizational computer network that is provided to the neural network(s) and/or generative AI model(s).

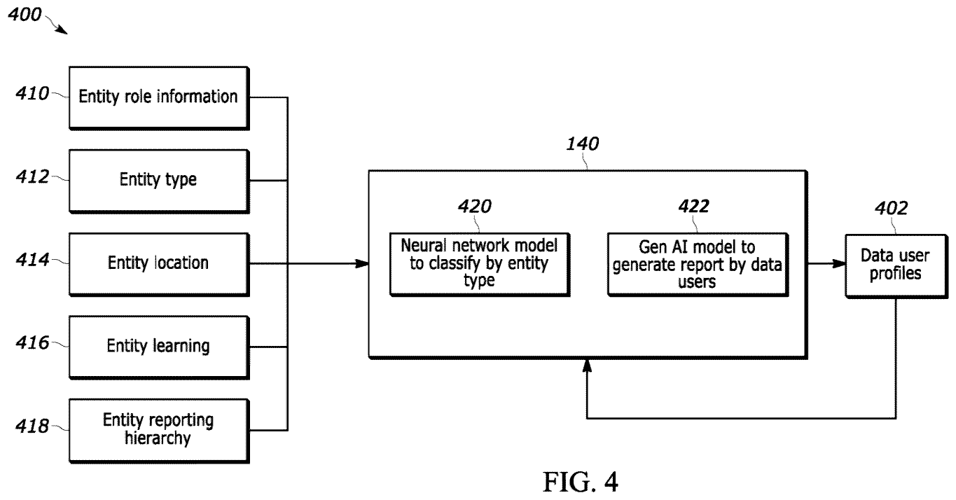

The method 300, and the methods described with respect to FIGS. 4-13, may be performed on a computing device that includes one or more processors and a non-transitory computer-readable medium that stores instructions for performing the method, such as the server computing device 102. Additionally or alternatively, the methods described with respect to FIGS. 3-13 may be performed by components that may encompass various data sources and intelligent systems. It should be appreciated that each of the methods 300-1300 may be performed as a routine separate from the method 200 (e.g., by the processor 120 of FIG. 1), in some aspects.

FIG. 4 illustrates a flow diagram representing a computer-implemented method 400 for generating data user profiles for an organizational computer network, according to some aspects. The method 400 includes processing data related to various people management platforms, including entity information such as role information, type, locations, learning, and reporting hierarchies, and utilizing machine learning models (e.g., via ML module 140 of FIG. 1) to classify the entity information and subsequently generate one or more data user profiles. The method 400 may include collecting entity information from people management platforms within the organizational computer network (blocks 410, 412, 414, 416, 418). This step involves analyzing and aggregating entity role information (410), entity types (412), entity locations (414), entity learning (416), and entity reporting hierarchies (418), which together provide a comprehensive view of the data users of the organizational computer network. The method 400 may include applying a neural network model to classify the entity information by entity type (block 420), as discussed with respect to FIG. 1, above. For example, the method 400 may include sorting and categorizing the entity information, using the neural network(s) based on entity types, characteristics, and relevance. The method 400 may include generating a report for the entity information associated with the organizational computer network by leveraging a generative artificial intelligence (AI) model (block 422). For example, the method 400 may include feeding the classified data into a generative AI model configured to process and synthesize the classified data to create a detailed report for the data users of the organizational computer network. In some embodiments, the method 400 may include generating one or more data user profiles using the generative AI model(s) and based on the classified data from the neural network(s). Further, the method 400 may include providing the one or more data user profiles (block 402) as an output. In some embodiments, the method 300 may include processing the generated data user profiles (e.g., via ML module 140) to further refine the contextual information provided to the one or more machine learning models.

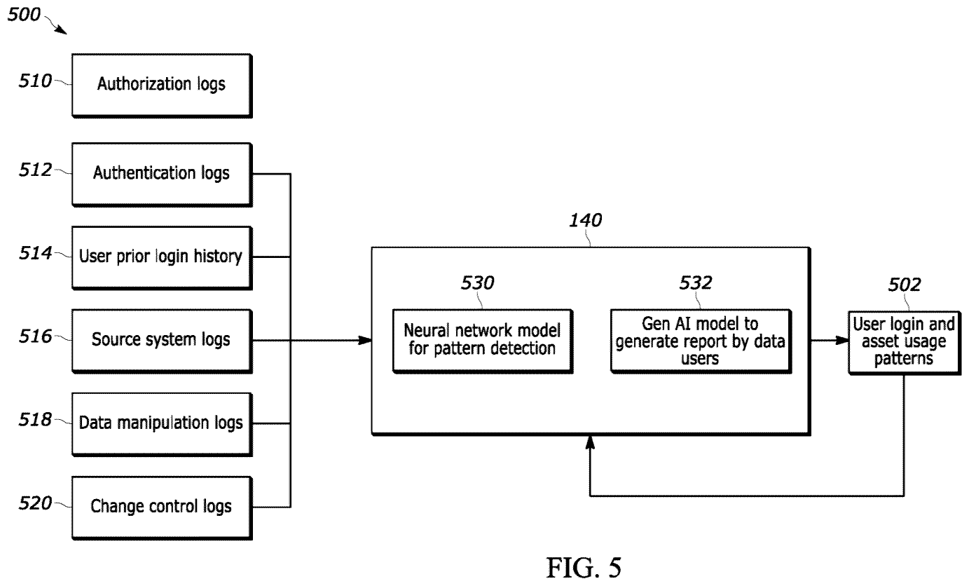

FIG. 5 illustrates a flow diagram representing a computer-implemented method 500 for generating user login and asset usage patterns for an organizational computer network, according to some aspects. The method 500 includes processing data related to machine generated logs, including various logs and reports such as authorization data, authentication data, prior login histories, source system data, data manipulation information, and change control data, and utilizing machine learning models (e.g., via ML module 140 of FIG. 1) to classify machine generated logs and subsequently generate one or more user login patterns and one or more asset usage patterns. The method 500 may include collecting machine generated logs from various components of the organizational computer network (blocks 510, 512, 514, 516, 518, 520). This step involves analyzing and aggregating authorization logs (510), authentication logs (512), user prior login histories (514), source system logs (516), data manipulation logs (518), and change control logs (520), which together provide a comprehensive view of user logins and asset usage within the organizational computer network. The method 500 may include applying a neural network model to detect login and usage patterns (block 530), as discussed with respect to FIG. 1, above. For example, the method 500 may include sorting and categorizing the machine generated logs, using the neural network(s) based on log types, characteristics, and relevance. Further, the method 500 may include analyzing the organized logs, using the neural network(s), to identify login patterns and data asset usage patterns. The method 500 may include generating a report for the machine generated logs associated with the organizational computer network by leveraging a generative artificial intelligence (AI) model (block 532). For example, the method 500 may include feeding the organized data and/or indications of the identified patterns into a generative AI model configured to process and synthesize the data to create a detailed report. In some embodiments, the method 500 may include generating one or more user login and asset usage patterns using the generative AI model(s) and based on the organized data from the neural network(s). Further, the method 500 may include providing the login and asset usage patterns (block 502) as an output. In some embodiments, the method 500 may include processing the generated login and asset usage patterns (e.g., via ML module 140) to further refine the contextual information provided to the one or more machine learning models.

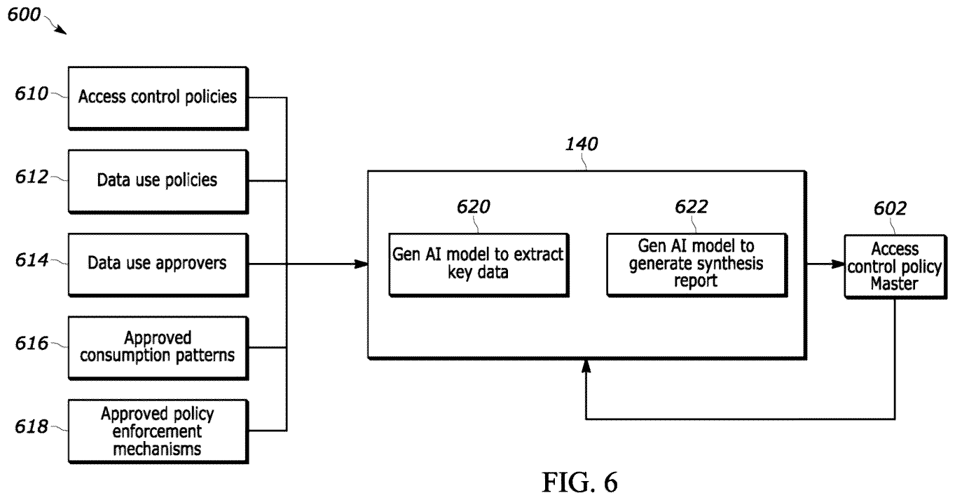

FIG. 6 illustrates a flow diagram representing a computer-implemented method 600 for generating access control policies for an organizational computer network, according to some aspects. The method 600 includes processing data related to role-based access controls (RBAC) and attribute-based access controls (ABAC), including data and/or information from one or more policy management tools, and utilizing machine learning models (e.g., via ML module 140 of FIG. 1) to classify the policy management data and subsequently generate one or more access control policies. The method 600 may include identifying existing RBAC and ABAC based on data collected from various policy management tools of the organizational computer network (blocks 610, 612, 614, 616, 618). This step involves analyzing and aggregating access control policies (610), data use policies (612), data use approvers (614), approved consumption patterns (616), and approved policy enforcement mechanisms (618), which together provide a comprehensive view of existing access control policies of the organizational computer network. The method 600 may include applying one or more first generative AI models to extract key data from the policy management data (block 620), as discussed with respect to FIG. 1, above. For example, the method 600 may include providing the policy management data to the first generative AI model(s), and the generative AI models may be configured (e.g., by instructions included in a prompt provided to the one or more models) to identify existing access control policies/information included in the policy management data. The method 600 may include generating a synthesis report for the policy management data associated with the organizational computer network by leveraging one or more second generative artificial intelligence (AI) models (block 622). For example, the method 600 may include feeding the identified key data and/or a prompt including a set of instructions into the second generative AI model(s). In some embodiments, the method 600 may include generating one or more access control policies and/or a access control policy master (e.g., a set of access controls policies for the organizational computer network) using the second generative AI model(s) and based on the identified key policy management data. Further, the method 600 may include providing the access control policies and/or access control policy master(block 602) as an output. In some embodiments, the method 600 may include processing the generated access control policies and/or policy master (e.g., via ML module 140) to further refine the contextual information provided to the one or more machine learning models.

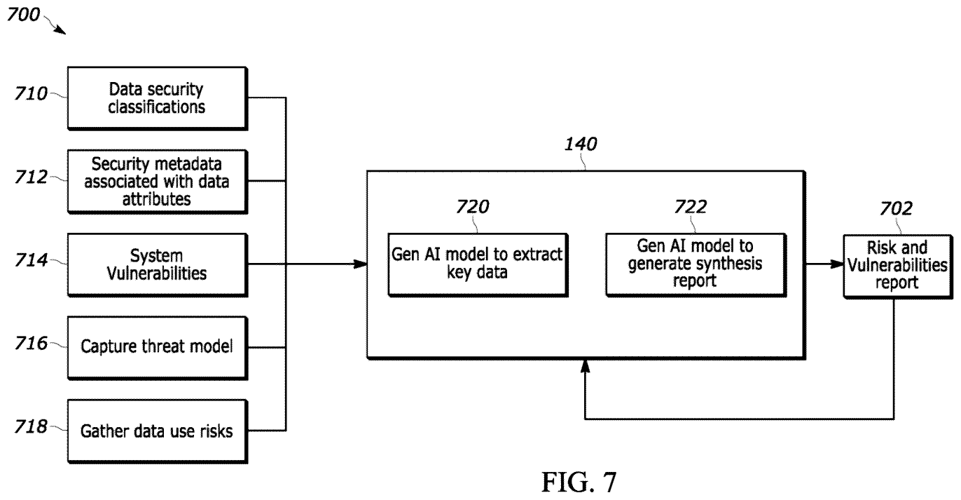

FIG. 7 illustrates a flow diagram representing a computer-implemented method 700 for generating risk and vulnerability reports for an organizational computer network, according to some aspects. The method 700 includes processing data related to various data security posture management tools, including security classifications, metadata, vulnerabilities, and risks, and utilizing machine learning models (e.g., via ML module 140 of FIG. 1) to classify the security posture data and subsequently generate one or more risk and vulnerability reports. The method 700 may include collecting security posture data from security posture management tools within the organizational computer network (blocks 710, 712, 714, 716, 718). This step involves analyzing and aggregating data security classifications (710), security metadata associated with data attributes (712), system vulnerabilities (714), data from one or more capture threat models (716), and gathered data use risks (718), which together provide a comprehensive view of the data security posture of the organizational computer network. The method 700 may include applying one or more first generative AI models to extract key data from the security posture data (block 720), as discussed with respect to FIG. 1, above. For example, the method 700 may include providing the security posture data to the first generative AI model(s), and the generative AI models may be configured to identify risks and vulnerabilities based on the security posture data. The method 700 may include generating a report for the security posture data associated with the organizational computer network by leveraging one or more second generative artificial intelligence (AI) models (block 722). For example, the method 700 may include providing the identified key data and/or a prompt including a set of instructions to the second generative AI model(s). In some embodiments, the method 700 may include generating one or more risk and vulnerability reports using the generative AI model(s) and based on the identified key security posture data. Further, the method 700 may include providing the risk and vulnerability report(s) (block 702) as an output. In some embodiments, the method 700 may include processing the generated risk and vulnerability reports (e.g., via ML module 140) to further refine the contextual information provided to the one or more machine learning models.

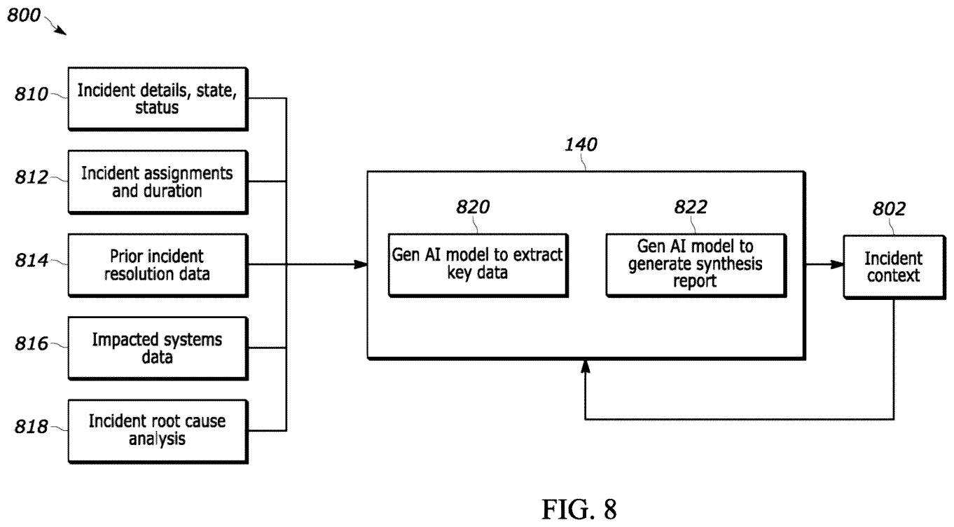

FIG. 8 illustrates a flow diagram representing a computer-implemented method 800 for generating incident context data for an organizational computer network, according to some aspects. The method 800 includes processing data related to various incident management tools, including incident information, details, assignments, and resolution data, and utilizing machine learning models (e.g., via ML module 140 of FIG. 1) to classify the incident management data and subsequently generate incident context data. The method 800 may include collecting incident management data from various data sources within the organizational computer network (blocks 810, 812, 814, 816, 818). This step involves analyzing and aggregating incident information (e.g., incident details, state, and status) (810), incident assignments and duration (812), prior incident resolution data (814), impacted systems data (816), and incident root cause analysis information (818), which together provide a comprehensive view of documented incidents associated with the organizational computer network. The method 800 may include applying one or more first generative AI models to extract key data from the incident management data (block 820), as discussed with respect to FIG. 1, above. For example, the method 800 may include providing the incident management data to the first generative AI model(s), and the generative AI models may be configured to identify particular incidents and associated data based on the incident management data. The method 800 may include generating a report for the incident management data associated with the organizational computer network by leveraging one or more second generative artificial intelligence (AI) models (block 822). For example, the method 800 may include providing the identified key data and/or a prompt including a set of instructions to the second generative AI model(s). In some embodiments, the method 800 may include generating incident context data using the generative AI model(s) and based on the identified key incident management data. Further, the method 800 may include providing the incident context data (block 802) as an output. In some embodiments, the method 800 may include processing the generated incident context data (e.g., via ML module 140) to further refine the contextual information provided to the one or more machine learning models.

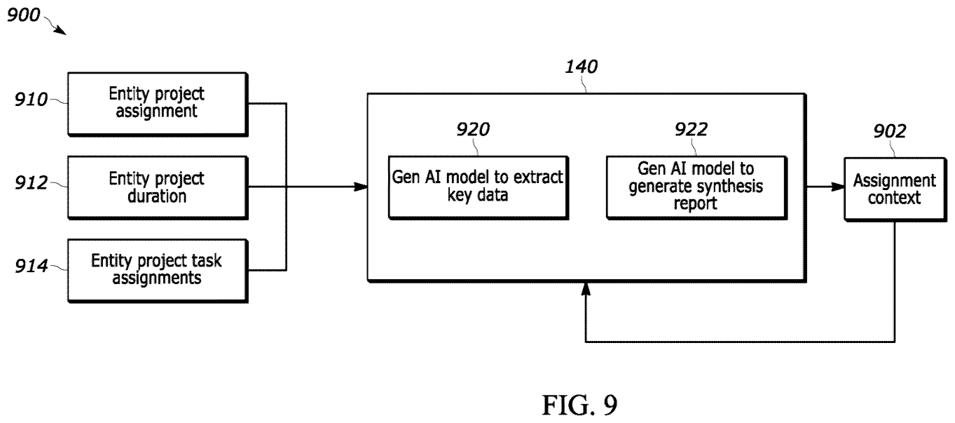

FIG. 9 illustrates a flow diagram representing a computer-implemented method 900 for generating assignment context data for an organizational computer network, according to some aspects. The method 900 includes processing data related to various project management tools, including project assignments, durations, and task assignments, and utilizing machine learning models (e.g., via ML module 140 of FIG. 1) to classify the project management data and subsequently generate assignment context data. The method 900 may include collecting the project management data from various project management tools within the organizational computer network (blocks 910, 912, 914). This step involves analyzing and aggregating entity project assignments (910), entity project duration (912), and entity project task assignments (914), which together provide a comprehensive view of entity assignments for the organizational computer network. The method 900 may include applying one or more first generative AI models to extract key data from the project management data (block 920), as discussed with respect to FIG. 1, above. For example, the method 900 may include providing the project management data to the first generative AI model(s), and the generative AI models may be configured to identify entity assignment information based on the project management data. The method 900 may include generating a report for the project management data associated with the organizational computer network by leveraging one or more second generative artificial intelligence (AI) models (block 922). For example, the method 900 may include providing the identified key data and/or a prompt including a set of instructions to the second generative AI model(s). In some embodiments, the method 900 may include generating assignment context data using the generative AI model(s) and based on the identified key project management data. Further, the method 900 may include providing the assignment context data (block 902) as an output. In some embodiments, the method 900 may include processing the generated assignment context data (e.g., via ML module 140) to further refine the contextual information provided to the one or more machine learning models.

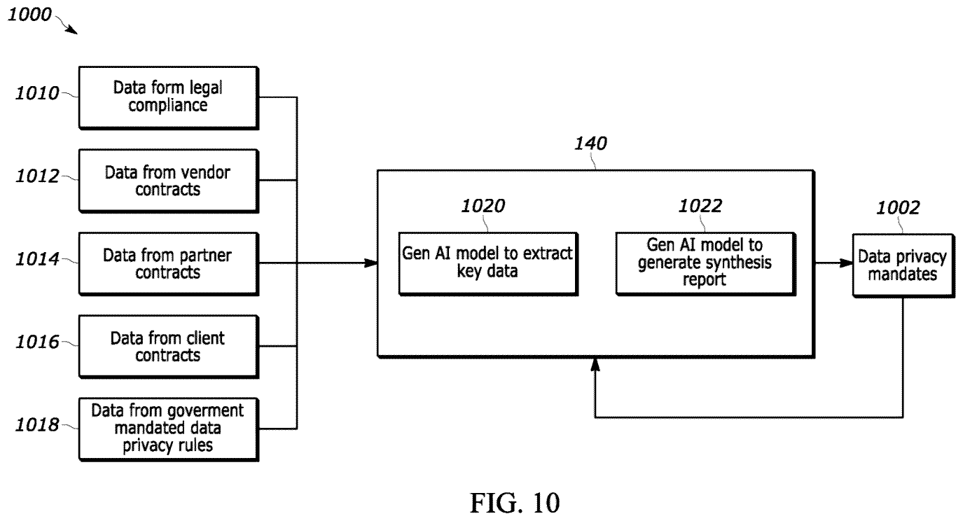

FIG. 10 illustrates a flow diagram representing a computer-implemented method 1000 for generating data privacy mandates for an organizational computer network, according to some aspects. The method 1000 includes processing data related to various risk and compliance management tools, including data associated with legal compliance, vendor contracts, partner contracts, client contracts, and government mandated data privacy rules, and utilizing machine learning models (e.g., via ML module 140 of FIG. 1) to classify the risks, contracts, and legal obligations data and subsequently generate one or more data privacy mandates. The method 1000 may include collecting risk data from various data sources within the organizational computer network (blocks 1010, 1012, 1014, 1016, 1018). This step involves analyzing and aggregating legal compliance data (1010), vendor contracts data (1012), partner contracts data (1014), client contracts data (1016), and government mandated data privacy rules information (1018), which together provide a comprehensive view of risks, contracts, and legal obligations associated with the organizational computer network. The method 1000 may include applying one or more first generative AI models to extract key data from the risk data (block 1020), as discussed with respect to FIG. 1, above. For example, the method 1000 may include providing the risk data to the first generative AI model(s), and the generative AI models may be configured to identify contracts, legal obligations, and other regulatory requirements based on the risk data. The method 1000 may include generating a report for the risk data associated with the organizational computer network by leveraging one or more second generative artificial intelligence (AI) models (block 1022). For example, the method 1000 may include providing the identified key data and/or a prompt including a set of instructions to the second generative AI model(s). In some embodiments, the method 1000 may include generating one or more data privacy mandates using the generative AI model(s) and based on the identified key risk data. Further, the method 1000 may include providing the data privacy mandates (block 1002) as an output. In some embodiments, the method 1000 may include processing the generated data privacy mandates (e.g., via ML module 140) to further refine the contextual information provided to the one or more machine learning models.

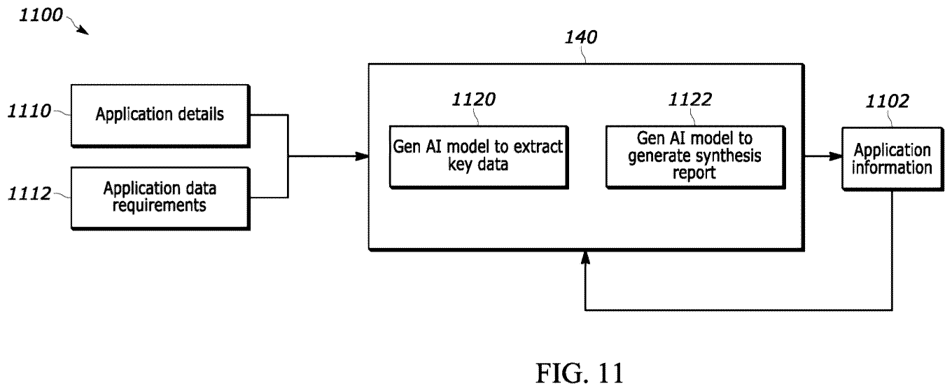

FIG. 11 illustrates a flow diagram representing a computer-implemented method 1100 for generating application information for an organizational computer network, according to some aspects. The method 1100 includes processing data related to various applications, including application details, data requirements, and data entitlements, and utilizing machine learning models (e.g., via ML module 140 of FIG. 1) to classify the collected application information and subsequently generate/identify key application information. The method 1100 may include collecting application information from various application executing in the organizational computer network (blocks 1110, 1112). This step involves analyzing and aggregating application details (1110), and application data requirements (1112), which together provide a comprehensive view of application data needs/requirements for the organizational computer network. The method 1100 may include applying one or more first generative AI models to extract key data from the application information (block 1120), as discussed with respect to FIG. 1, above. For example, the method 1100 may include providing the application information to the first generative AI model(s), and the generative AI models may be configured to identify application data entitlements, application data requirements, and application details/specifications based on the collected application information. The method 1100 may include generating a report for the collected application information associated with the organizational computer network by leveraging one or more second generative artificial intelligence (AI) models (block 1122). For example, the method 1100 may include providing the identified key data and/or a prompt including a set of instructions to the second generative AI model(s). In some embodiments, the method 1100 may include generating a synthesis report using the generative AI model(s) and based on the identified key application information. Further, the method 1100 may include providing the key application information (block 1102) as an output. In some embodiments, the method 1100 may include processing the generated key application information (e.g., via ML module 140) to further refine the contextual information provided to the one or more machine learning models.

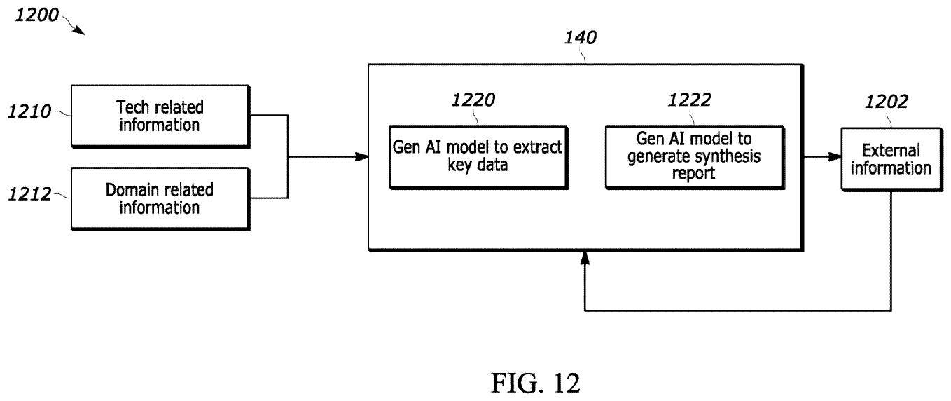

FIG. 12 illustrates a flow diagram representing a computer-implemented method 1200 for generating external information for an organizational computer network, according to some aspects. The method 1200 includes processing data related to various external components of the organizational computer network such as external data sources, external applications, external devices, etc., and utilizing machine learning models (e.g., via ML module 140 of FIG. 1) to classify the collected external component information and subsequently generate/identify key information. The method 1200 may include collecting external component information from various external data sources of the organizational computer network (blocks 1210, 1212). This step involves analyzing and aggregating technology related information (1210), and domain related information (1212), which together provide a comprehensive view of external component data needs/requirements for the organizational computer network. The method 1200 may include applying one or more first generative AI models to extract key data from the external information (block 1220), as discussed with respect to FIG. 1, above. For example, the method 1200 may include providing the external information to the first generative AI model(s), and the generative AI models may be configured to identify external component data entitlements, external component data requirements, and external component details/specifications based on the collected external component information. The method 1200 may include generating a report for the collected external component information associated with the organizational computer network by leveraging one or more second generative artificial intelligence (AI) models (block 1222). For example, the method 1200 may include providing the identified key data and/or a prompt including a set of instructions to the second generative AI model(s). In some embodiments, the method 1200 may include generating a synthesis report using the generative AI model(s) and based on the identified key external component information. Further, the method 1200 may include providing the key external component information (block 1202) as an output. In some embodiments, the method 1200 may include processing the generated key external component information (e.g., via ML module 140) to further refine the contextual information provided to the one or more machine learning models.

FIG. 13 illustrates a flow diagram representing a computer-implemented method 1300 for generating data access controls for an organizational computer network, according to some aspects. In some embodiments, the method 1300 includes processing data generated by the machine learning models described with respect to FIGS. 3-12. For example, the method 1300 may include processing data such as data asset consumption profiles, data user profiles, user login and asset usage patterns, access control policies, risk and vulnerability reports, incident context data, assignment context data, data privacy mandates, application information, external information, and utilizing one or more machine learning models (e.g., via ML module 140 of FIG. 1) to generate data access controls for the organizational computer network.

As mentioned above, the method 1300 may include obtaining/processing data from various input sources (block 1302). Generally, the method 1300 may include obtaining data relevant to generating data access controls for an organizational computer network. In some embodiments, the method 1300 may include processing the data collected at block 1302 via the ML module 140.

At block 1310, the ML module 140 generates user entitlements and data access behaviors using a first neural network model. For example, the first neural network model may be trained on historical data access requests and existing user entitlements to identify the influence of user entitlements on data access patterns.

At block 1312, the ML module 140 generates and/or classifies data asset risks, role explosions, and vulnerabilities using a second neural network. For example, the second neural network model may be trained on historical security risks associated with particular data assets, existing role assignments, and known vulnerabilities to identify potential data asset risks, role explosions, and vulnerabilities.

At block 1314, the ML module 140 generates data asset classifications, patterns, and usage controls using a third neural network. For example, the third neural network model may be trained on existing data asset classifications and usage patterns to determine appropriate usage controls that align with policies and compliance requirements of the organizational computer network.

At block 1316, the ML module 140 processes the data from the neural network models to generate a plurality of data access patterns using a first generative AI model. For example, the data access patterns may represent how data access is structured, accessed, and exchanged within the organizational computer network. Further, the user entitlements, data access behaviors, data asset risks, role explosions, vulnerabilities, data asset classifications, patterns, and usage controls provide a detailed overview of common, uncommon, and high risk data access patterns within the organizational computer network.

At block 1318, the ML module 140 generates individual-based user entitlements and group-based user entitlements using a second generative AI model based on the data access patterns from the first generative AI model. In some embodiments, the ML module 140 may generate a reasoning of access summary for each generated user entitlement.

In some embodiments, the ML module 140 may implement reinforcement learning (block 1320) for one or more of the first, second or third neural networks and/or the first or second generative AI model. Additionally or alternatively, the ML module 140 may finetune the ML models and/or refine the output of the ML models using human feedback. For example, the ML module 140 may implement reinforcement learning to refine the generated data access patterns and user entitlements.

At block 1304, the ML module 140 may output data access controls for the organizational computer network including the individual-based user entitlements and group-based user entitlements. In some embodiments, the ML module 140 may use the generated data access controls, and/or existing data access controls for the organizational computer network, to further refine and/or train the machine learning models (e.g., first, second and third neural networks; first and second generative AI models).

### Example Simulated Data Access Environment

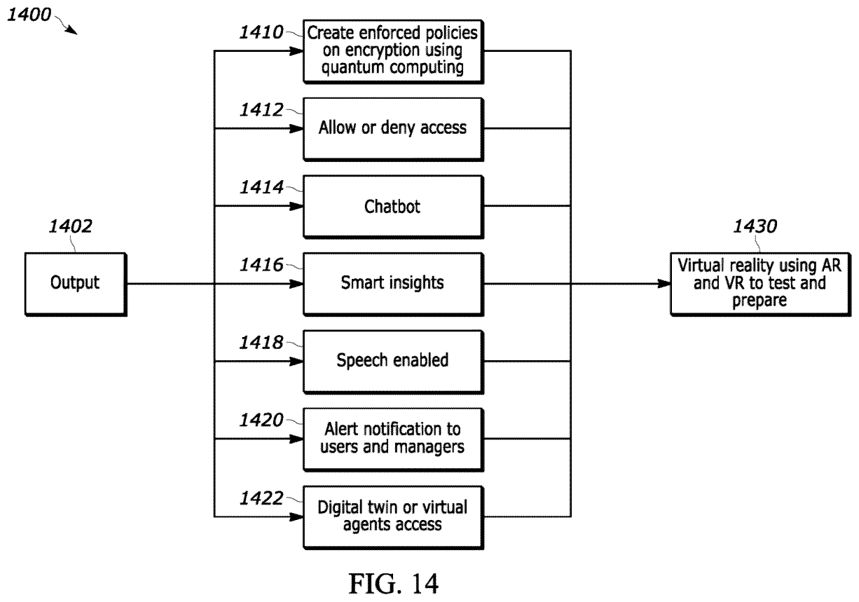

FIG. 14 illustrates a flow diagram representing a computer-implemented method 1400 for various implementations of AI-based data access control, according to some aspects. In some embodiments, the method 1400 may include generating the output data 1402 (e.g., information management data) using one or more machine learning models. Generally, the output data 1402 is generated via the ML models described herein and/or may include the information management data (preprocessed or unprocessed) described herein. In some embodiments, the output data 1402 may include AI-based data access controls as described with respect to FIGS. 1-13.

In some embodiments, the method includes creating enforced policies on encryption using quantum computing (block 1410). Additionally or alternatively, the method 1400 may include establishing and enforcing data encryption policies that leverage advanced computational power of quantum computing. By ensuring that data within the organizational computing network is protected by quantum encryption standards, potential quantum computing-based threats can be avoided and/or eliminated. In some embodiments, the method includes allowing or denying access (block 1412), e.g., to a user of the organizational computer network, and/or another entity of the network. For example, the method 1400 may include applying data access controls (as described with respect to FIGS. 1-13), or a subset of access controls, to one or more data access requests within the organizational computer network. In some embodiments, the method includes providing the output data 1402, or a portion thereof, to a chatbot (block 1414). For example, the method 1400 may include utilizing a chatbot that facilitates user interactions and allows users to query information, request access, or receive guidance on system usage. In some embodiments, the method 1400 includes developing a fine-tuned generative transformer model (a chatbot) as described with respect to FIGS. 16-17. In some embodiments, the method includes providing smart insights (block 1416) regarding, for example, data access information for the organizational computer network and diagnostics data for the organizational computer network. In some embodiments, the method includes utilizing speech enabled features (block 1418) to provide data and/or information to a user of the organizational computer network. For example, the method 1400 may include providing smart insights (block 1416) to a user via an audio output device (e.g., an output device included in user computing device 104 of FIG. 1). In some embodiments, the method includes providing alert notification(s) to users and managers (block 1420). For example, the method 1400 may include providing alerts to one or more user computing devices (e.g., user computing devices 104 of FIG. 1). In some embodiments, the method includes generating digital twin(s) and/or virtual agents access (block 1422). Additionally or alternatively, the method 1400 may include simulating the organizational computer network to facilitate testing, training, or operational analysis.

In some embodiments, the method includes implementing virtual reality (VR) and/or augmented reality (AR) to test and validate data access controls (block 1430). For example, the method 1400 may include using VR and AR for testing, preparation, and/or immersive user experiences.

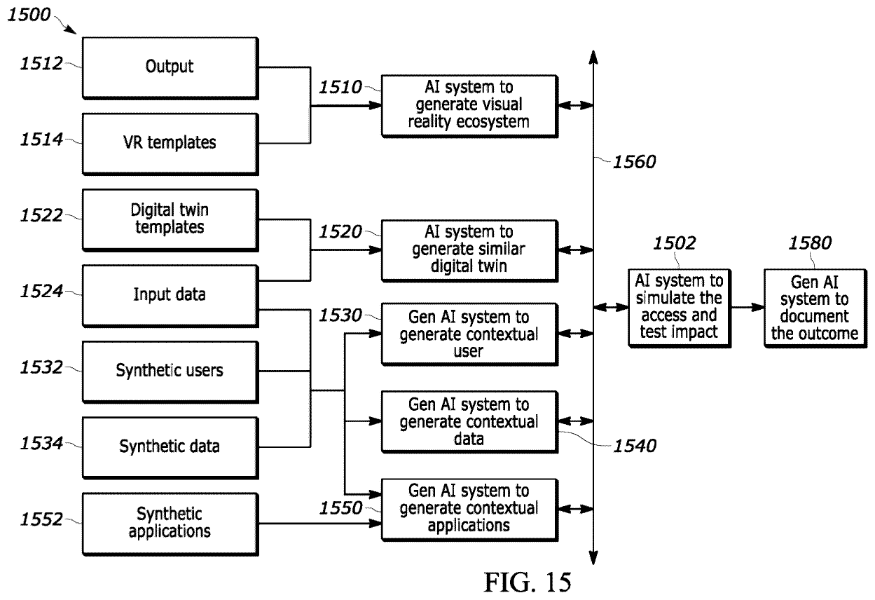

FIG. 15 illustrates a block flow diagram representing a computer-implemented method 1500 for simulating a data access environment, according to some aspects. The method 1500 may include simulating data access using one or more generative AI models and/or one or more ML models to test the impact of implementing AI-based data access controls (block 1502). Generally, the method 1500 involves leveraging machine learning and artificial intelligence models to create a realistic representation of data access scenarios to evaluate the effectiveness of AI-based data access controls within a virtual computing environment.

The method 1500 includes implementing an artificial intelligence (AI) system configured to generate a simulated data access environment. For example, the AI system may include a first generative AI model and/or ML model (block 1510), a second generative AI model and/or ML model (block 1520), a third generative AI model and/or ML model (block 1530), a fourth generative AI model and/or ML model (block 1540), and/or a fifth generative AI model and/or ML model (block 1550). In some embodiments, one or more of the first, second, third, fourth, or fifth models may be connected by a bus 1560 and/or another communication link(s). Further, each of the ML/AI models may be communicatively connected (e.g., via bus 1560) and may be configured to exchange data and/or information. This interconnected system of AI/ML models facilitates a comprehensive simulation by allowing the models to share insights and data, thereby enhancing the accuracy and depth of the simulated data access environment.

At block 1510, the first model generates a virtual data access environment. In some embodiments, the method 1500 may include generating the virtual data access environment by inputting output data 1512 and/or VR templates 1514 to the first model.

At block 1520, the second model generates one or more similar digital twins for the virtual data access environment. In some embodiments, the method 1500 may include generating the one or more similar digital twins by inputting digital twin templates 1522 and/or input data 1524 to the second model. Digital twins may serve as accurate replicas of components of a physical data access environment, enabling detailed analysis and testing of data access controls within a safe, simulated setting.

At block 1530, the third model generates one or more contextual users for the virtual data access environment. In some embodiments, the method 1500 may include generating the one or more contextual users by inputting input data 1524, synthetic users 1532, and/or synthetic data 1534 to the third model. Contextual users may represent virtual entities with specific roles, behaviors, and access requirements, thereby providing a realistic user base for testing data access controls.

At block 1540, the fourth model generates contextual data for the virtual data access environment. In some embodiments, the method 1500 may include generating the contextual data by inputting input data 1524, synthetic users 1532, and/or synthetic data 1534 to the fourth model. The contextual data encompasses a wide range of information types and formats, and generally provides additional contextual data (e.g., beyond entity and/or application information) for simulating the diverse data landscape of real-world computing environments.

At block 1550, the fifth model generates contextual applications for the virtual data access environment. In some embodiments, the method 1500 may include generating the contextual applications by inputting input data 1524, synthetic users 1532, synthetic data 1534, and/or synthetic applications 1552 to the fifth model. The contextual applications generally represent various software tools and platforms through which users may interact with the virtual data access environment.

In operation, the generative AI models and ML models of blocks 1502-1550 simulate access to the virtual data access environment, test the impact of various scenarios, generate contextual information related to virtual users, data, and applications within the ecosystem. In some embodiments, the method includes documenting the outcome of simulating the data access environment using one or more generative AI models (block 1580). The simulation process of the method 1500 allows for the evaluation of data access controls in a virtual setting, enabling the identification and mitigation of potential risks and vulnerabilities associated with data access. Furthermore, by evaluating generate data access controls as such, the effectiveness and reliability of data access controls can be validated before implementation in real-world environments.

As described above, an example system utilizes real-world user profiles, real-world data assets, real-world logs, and other real-world information management data to generate data asset controls using one or more generative AI models. Additionally or alternatively, the data access controls can be generated and/or tested in a virtual computing environment simulated using virtual user profiles, virtual data assets, virtual security risks, and other contextual data. For example, the virtual user profiles may be similar to real-world user profiles for an organizational computer network and may include users having similar roles, demographics, etc., as the roles in the real-world organization. The virtual data assets may also be similar to the real-world data assets and may include similar files, folders, etc., as in the real-world organization.

Also in some implementations, these data asset controls can be tested in the virtual computing environment using virtual data asset requests. Further, an example system may simulate virtual users requesting access to the data, and receiving access in accordance with the generated data access controls. Then the system may generate the one or more data access metrics (a data asset risk metric, a data asset role explosion metric, and/or a data asset vulnerability metric) to assess the performance of the data access controls. In some implementations, the system can compare the metrics to threshold metrics, and if the metrics exceed the thresholds, the system may deploy the access controls in the real-world organizational computing network. Otherwise, the system may make adjustments to the data access controls based on the metrics. In some scenarios, the system may test the adjusted data access controls in the virtual computing environment and repeat this process until the metrics for the data access controls exceed the thresholds.

As used herein, there terms “virtual”, “simulated”, and variations thereof may refer to the creation and operation of a digital representation or model of a real-world computing environment, including its data assets and sources, entities, security risks and vulnerabilities, and interactions (e.g., typical data access patterns), for the purpose of testing and analyzing AI-based access controls (e.g., generated as described above with respect to FIGS. 1-13) without affecting an actual computing environment.

As used herein, the term “contextual data” may refer to additional information that provides background, circumstances, or situational awareness relevant to the understanding, interpretation, and management of data assets and access controls within a computing environment.

### Example Language Model Architecture

FIG. 16 depicts a block-flow diagram outlining a method 1600 for building and applying an artificial intelligence model, specifically a language model (LM), according to some aspects. The method 1600 may include the creation and/or utilization of an LM to develop an access control assistant. The method 1600 begins with data preparation and sampling (block 1602), which includes processing data pertinent to a given application of the LM. Subsequently, the method 1600 involves the construction of an LM (block 1604) which encompasses the formulation of the model's architecture (block 1606), as well as pretraining (block 1608) with an attention mechanism (block 1610). The pretraining phase is undertaken to establish a foundational model (block 1612) that learns from the prepared data, suited to the LM's intended use. Within the foundational model (block 1612), additional steps of training (block 1614) and model evaluation (block 1616) are performed. During this phase, the model may also benefit from pretrained weights (block 1618), which can accelerate the training by drawing on previously acquired patterns and knowledge.

After the foundational model is established, the process includes finetuning (block 1620), which is the calibration and optimization stage, utilizing more focused data pertaining to the specific application of the LM. This phase is crucial for honing the LM to produce accurate outcomes within its intended operational domain. Finally, an instructions dataset (block 1624) is provided to the access control assistant (block 1601). This dataset could contain structured instructions and prompts that facilitate the LM in generating relevant analyses and responses. These prompts promote the practical implementation of the trained model, enabling it to function effectively as part of the access control assistant. FIG. 16 illustrates a structured approach for developing a specialized LM aimed at a certain application, starting with data preparation and sampling, progressing through model construction with architecture development and pretraining, and culminating in the finetuning and deployment of a access control assistant that operates in conjunction with a dedicated instructions dataset. This visual aid encapsulates the sequence of steps necessary to forge a tool that supports the specific application for which the LM is designed, according to some aspects.

The language model (LM) outlined in method 1600 directly supports the functions of the ML module 140 within the computing environment. The LM's initial steps of data preparation and sampling (block 1602) align with the data collection and preparation activities of the ML module 140 and the data access module 150 to develop ML models that can accurately assess and manage data access environments and/or controls. This module utilizes a variety of data sources, including data management tools, user management tools, applications, code repositories, knowledge bases and other data access resources to train neural network models and generative AI models.

The construction phase of the LM, including the formulation of the model's architecture (block 1606) and pretraining with an attention mechanism (blocks 1608 and 1610), parallels the development process within the ML module 140. This process involves using machine learning and data science libraries to build models capable of understanding and predicting idea data access controls.

The foundational model (block 1612) of the LM, which undergoes additional training (block 1614) and evaluation (block 1616), reflects the iterative training and refinement process of ML models within the ML module 140. This module may leverage historical data and coding practices to enhance the accuracy and efficiency of the AI-based data access control process.

The finetuning stage (block 1620) of the LM is crucial for optimizing the model's performance for its specific application, mirroring the continuous improvement efforts of the ML module 140 to ensure the models remain relevant and accurate as the data access needs and requirements of an organization evolves.

Finally, the instructions dataset (block 1624) provided to the access control assistant (block 1601) enables the practical application of the LM within the computing environment. For example, the ML module 140 and/or the data access module 150 may apply trained ML models to new data, and/or organizational computer networks, to assess current data access needs/requirements and recommend new or updated data access controls for the organizational computer network.

FIG. 17 illustrates a neural network-based model architecture for processing and analyzing data related to data access environments (block 1702). The process begins with data collection (block 1730) which is then passed through preprocessing layers, specifically a data normalization layer (block 1712a) and a feature extraction layer (block 1712b). These layers are followed by a dropout layer (block 1714) to prevent overfitting. The core of the architecture is the neural network loop (block 1716), which is iterated N times, where N is a positive integer. Each iteration consists of a normalization layer (block 1720a), followed by an attention layer (block 1722) with its own dropout layer (block 1724a), another normalization layer (block 1720b), a dense layer (block 1726), and another dropout layer (block 1724b). The process concludes with a final normalization layer (block 1717) and a linear output layer (block 1718), producing the final output from the neural network-based model. This architecture is designed to handle and analyze data for identifying and managing data access needs and requirements within a computing environment.

The model architecture depicted in FIG. 17 may be used to analyze and evaluate data access needs and requirements, particularly in the context of identifying inefficiencies, compliance gaps, and modernization opportunities for existing data access controls of an organizational computer network. This neural network-based architecture facilitates the processing of diverse data through a series of layers and loops designed to understand and identify patterns related to data access and management. Initially, the collected data is processed through preprocessing layers, including normalization and feature extraction layers, which help the model understand the significance of each data point within the context of data access for each entity of a computing environment (e.g., users, applications, other entities capable of exchanging data within the environment). This is crucial for effectively managing data access as it allows the system to grasp the nuances of the organization's data access environment, including outdated technologies/controls, compliance issues, and potential areas for improvement. The dropout layers introduced after the preprocessing layers and within the neural network loop serve to prevent overfitting by randomly omitting some of the units from the layers during training. This ensures that the model does not become too reliant on the training data, allowing it to generalize better to new, unseen data. The neural network loop, iterated N times, is where the bulk of the analysis happens. Each iteration consists of a series of layers including normalization, attention, and dense layers, each followed by dropout layers. The normalization layers help stabilize the learning process, while the attention layers allow the model to focus on different parts of the input data to better understand the relationships between various factors effecting data access with the organizational computer network. The dense layers, on the other hand, are fully connected layers that help in learning non-linear combinations of the features. The final normalization layer ensures that the data is normalized before passing it to the linear output layer, which produces the final output of the model.

By leveraging the capabilities of AI-based data access control, individuals can engage with an example machine learning model to evaluate (e.g., quantify and score) existing data access controls and generate updated or new access controls based on the evaluation. As mentioned above, an example method may include collecting and analyzing data from diverse sources within a computing environment, such as data management tools, user management tools, applications, code repositories, knowledge bases, and other data access resources. By interacting with a language model (LM) trained on a variety of such data (e.g., the LM of FIG. 16 and FIG. 17), individuals can improve and refine data access management techniques at least by providing informed changes to existing access controls/techniques and leveraging a diverse knowledge base to identify potential issues with existing access controls/techniques. For example, an LM can be used to identify a compliance issue associated with existing access controls and generate an updated subset of access controls (e.g., one or more data access entitlements) based on regulatory information from a compliance management tool of the organizational computer network. Additionally, LMs can be used to summarize existing or generated access controls, or portions thereof, in order to facilitate human/user review. The data access module 150 within the computing environment may, generally, provide preprocessed information management data (e.g., data access entitlement, data access patterns, compliance and regulatory information, etc.) and a set of instructions (e.g., instructions dataset 1624 of FIG. 16) to one or more ML models (e.g., models stored and/or operated by ML module 140 of FIG. 1) such as one or more neural networks, one or more generative AI models (e.g., LMs of FIG. 16 and FIG. 17, which are trained using structured and unstructured data from the organization's data access environment. Furthermore, the data access module 150 may apply the trained ML models to new and unseen data, enabling the system to generate data access controls for an organizational computer network lacking existing data access controls.

### Example Computer-Implemented Method

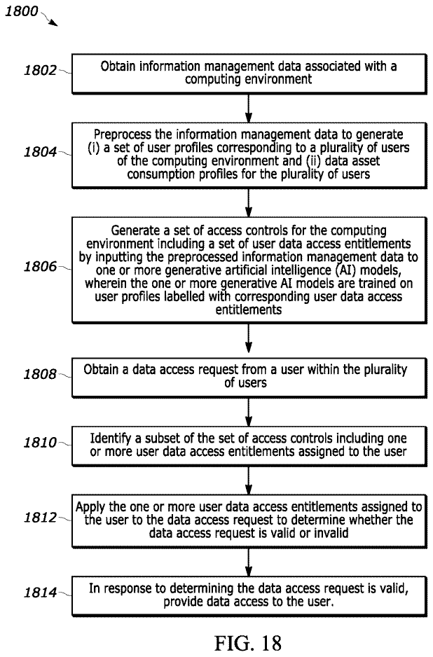

FIG. 18 depicts a computer-implemented method 1800 for artificial intelligence-based data access control. The method 1800 may be performed on a computing device that includes one or more processors and a non-transitory computer-readable medium that stores instructions for performing the method, such as the server computing device 102.

The method 1800 begins with obtaining information management data associated with a computing environment (block 1802). In some embodiments, the information management data is obtained from a people management platform, a network monitoring system, one or more data management tools, an incident management tool, a project management tool, a compliance information data source, one or more external applications, and/or one or more external information technology (IT) data sources. In some embodiments, the one or more data management tools include one or more of: a data management policy tool, a data security posture management tool, or a comprehensive data management tool. In some embodiments, the preprocessed information management data includes data asset consumption profiles, data user profiles, user login and asset usage patterns, access control policies, risk and vulnerability data, incident data, project data, data privacy mandates, application information, and/or external information.

Next, the method includes preprocessing the information management data to generate (i) a set of user profiles corresponding to a plurality of users of the computing environment and (ii) data asset consumption profiles for the plurality of users (block 1804). In some embodiments, preprocessing the information management data comprises codifying the information management data using one or more machine learning (ML) models. Additionally or alternatively, preprocessing the information management data may comprise generating the preprocessed information management data by inputting the codified information management data to a generative AI model. In some embodiments, codifying the information management data comprises identifying current user data access entitlements and data access behaviors included in the information management data using a first artificial neural network (ANN). Additionally or alternatively, codifying the information management data may comprise classifying data asset risks, data asset role explosions, and data asset vulnerabilities by inputting the information management data to a second ANN; Further, codifying the information management data may include identifying data asset classifications, data asset patterns, and data asset usage controls included in the information management data using a third ANN. In some embodiments, preprocessing the information management data further comprises identifying current access control policies for the computing environment by inputting the information management data to the one or more ML models.

Following preprocessing the information management data, the method involves generating a set of access controls for the computing environment including a set of user data access entitlements by inputting the preprocessed information management data to one or more generative artificial intelligence (AI) models, wherein the one or more generative AI models are trained on user profiles labelled with corresponding user data access entitlements (block 1806). In some embodiments, generating the set of access controls comprises generating data access patterns based on the data asset consumption profiles and the data access behaviors by inputting the preprocessed information management data to a first generative AI model. Additionally or alternatively, generating the set of access controls may comprise generating the set of user data access entitlements by inputting the data access patterns to a second generative AI model. In some embodiments, the set of user data access entitlements include: data access entitlements for individual users, and data access entitlements for one or more groups of users. In some embodiments, the data access entitlements for the one or more groups of users include one or more security group data access entitlements. In some embodiments, generating the set of access controls further comprises generating updated access control policies based on the current access control policies by inputting the preprocessed information management data to the one or more generative AI models. Additionally or alternatively, generating the set of access controls may further comprise converting the updated access control policies into the set of access controls by inputting the updated access control policies the one or more generative AI models.

Next, the method includes obtaining a data access request from a user within the plurality of users (block 1808). In some embodiments, the plurality of users include one or both of: one or more users, or one or more computing users.

Next, the method includes identifying a subset of the set of access controls including one or more user data access entitlements assigned to the user (block 1810). In some embodiments, generating the set of access controls includes generating a set of enforcement policies including a requirement that data accessible by the plurality of users of the computing environment is encrypted using quantum-resistant encryption.

Next, the method includes applying the one or more user data access entitlements assigned to the user to the data access request to determine whether the data access request is valid or invalid (block 1812). In some embodiments, the data access request is valid in a first instance, and the method may further involve in a second instance: in response to determining the data access request is invalid, denying data access for the user. In some embodiments, the method may further involve generating an explanation for why the data access request is invalid by inputting the one or more user data access entitlements assigned to the user and the data access request to the one or more generative AI models. Additionally or alternatively, the method may involve providing the explanation for presentation to the user.

Finally, in response to determining the data access request is valid, the method includes providing data access to the user (block 1814).

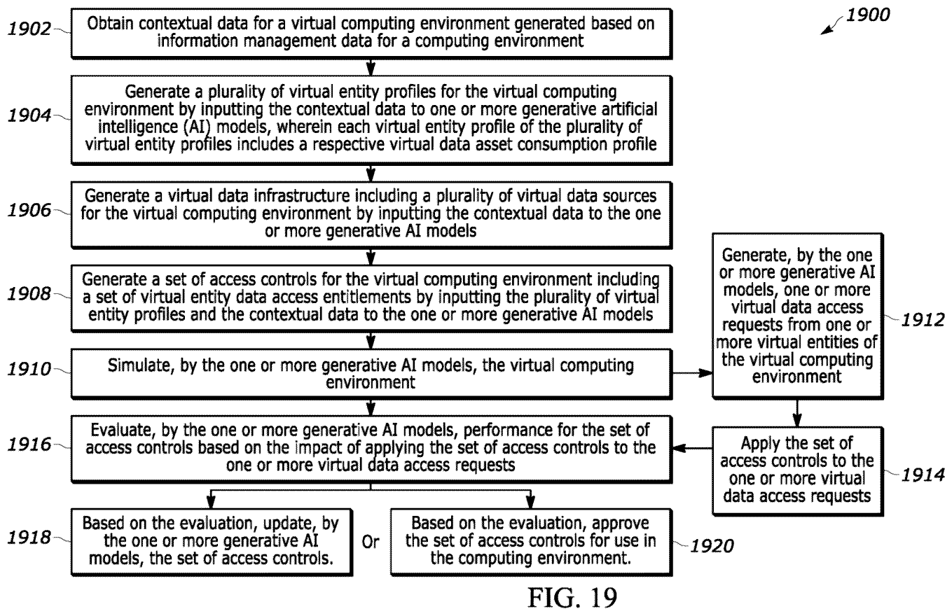

FIG. 19 depicts a computer-implemented method 1900 for artificial intelligence-based data access control. The method 1900 may be performed on a computing device that includes one or more processors and a non-transitory computer-readable medium that stores instructions for performing the method, such as the server computing device 102.

The method 1900 begins with obtaining contextual data for a virtual computing environment generated based on information management data for a computing environment (block 1902). In some embodiments, the method may involve preprocessing the information management data for the computing environment to generate the contextual data for the virtual computing environment. In some embodiments, preprocessing the information management data for the computing environment comprises codifying the information management data using one or more machine learning (ML) models. Additionally or alternatively, preprocessing the information management data for the computing environment may comprise generating the contextual data by inputting the codified information management data to the one or more generative AI models. In some embodiments, codifying the information management data for the computing environment comprises identifying access data included in the information management data using a first artificial neural network (ANN), wherein the access data includes current user data access entitlements of the computing environment and data access behaviors of the computing environment. Additionally or alternatively, codifying the information management data for the computing environment may comprise classifying asset data of the computing environment by inputting the information management data to a second ANN. In some embodiments, classifying the asset data includes: classifying data asset risks of the computing environment, classifying data asset role explosions of the computing environment, and/or classifying data asset vulnerabilities of the computing environment. In some embodiments, codifying the information management data for the computing environment comprises identifying additional asset data included in the information management data using a third ANN, wherein the additional asset data includes data asset classifications of the computing environment, data asset patterns of the computing environment, and data asset usage controls of the computing environment.

In some embodiments, generating the contextual data for the virtual computing environment further comprises, based on the access data and the additional asset data, generating, by the one or more generative AI models, a first portion of the contextual data including one or more of entity profiles, entity login patterns, entity asset usage patterns, application information, project data, or external information. Additionally or alternatively, generating the contextual data for the virtual computing environment may further comprise, based on the classified asset data and the additional asset data, generating, by the one or more generative AI models, a second portion of the contextual data including one or more of access control policies, risk and vulnerability data, incident data, or data privacy mandates.

Next, the method includes generating a plurality of virtual entity profiles for the virtual computing environment by inputting the contextual data to one or more generative artificial intelligence (AI) models, wherein each virtual entity profile of the plurality of virtual entity profiles includes a respective virtual data asset consumption profile (block 1904). In some embodiments, the method may involve generating, by the one or more generative AI models, a plurality of data asset consumption profiles of the computing environment based on at least the entity profiles and the entity asset usage patterns, wherein the contextual data includes the plurality of data asset consumption profiles.

Following generating the plurality of virtual entity profiles, the method involves generating a virtual data infrastructure including a plurality of virtual data sources for the virtual computing environment by inputting the contextual data to the one or more generative AI models (block 1906).

Next, the method includes generating a set of access controls for the virtual computing environment including a set of virtual entity data access entitlements by inputting the plurality of virtual entity profiles and the contextual data to the one or more generative AI models (block 1908). In some embodiments, at least one generative AI model of the one or more generative AI models is trained on historical entity profiles labelled with corresponding historical data access entitlements. In some embodiments, generating the set of access controls comprises generating virtual data access patterns based on the virtual data asset consumption profiles and the data access behaviors by inputting the preprocessed information management data to a first generative AI model. Additionally or alternatively, generating the set of access controls may comprise generating the set of virtual entity data access entitlements by inputting the virtual data access patterns to a second generative AI model. In some embodiments, the set of virtual entity data access entitlements include: data access entitlements for individual virtual entities, and data access entitlements for one or more groups of virtual entities. In some embodiments, the data access entitlements for the one or more groups of virtual entities include one or more security group data access entitlements.

Following generating the set of access controls, the method involves simulating the virtual computing environment (block 1910). In some embodiments, the method involves simulating the virtual computing environment by generating, by the one or more generative AI models, one or more virtual data access requests from one or more virtual entities of the virtual computing environment (block 1912) and applying the set of access controls to the one or more virtual data access requests (block 1914). In some embodiments, applying the set of access controls to a data access request from a virtual entity comprises identifying a subset of the set of access controls including one or more virtual entity data access entitlements assigned to the virtual entity. Additionally or alternatively, applying the set of access controls to a data access request from a virtual entity may comprise applying at least one virtual entity data access entitlement of the one or more virtual entity data access entitlements assigned to the virtual entity to the data access request to determine whether the data access request is valid or invalid. In some embodiments, applying the set of access controls to a data access request from a virtual entity comprises, in response to determining the data access request is valid, providing data access to the virtual entity.

Following simulating the computing environment, the method involves evaluating, by the one or more generative AI models, performance for the set of access controls based on the impact of applying the set of access controls to the one or more virtual data access requests (block 1916). In some embodiments, evaluating performance for the set of access controls comprises, in response to applying the set of access controls to the one or more data access requests, generating one or more data access metrics. In some embodiments, the one or more data access metrics include one or more of: a data asset risk metric, a data asset role explosion metric, and/or a data asset vulnerability metric. Additionally or alternatively, evaluating performance for the set of access controls may comprise evaluating the impact of providing data access to the one or more virtual entities with respect to one or more of: data asset risks, data asset role explosions, and data asset vulnerabilities.

Finally, the method includes: updating, by the one or more generative AI models, the set of access controls based on the evaluation (block 1920) and/or approving the set of access controls for use in the computing environment based on the evaluation (block 1922). For example, the method 1900 may include comparing the one or more data access metrics to respective thresholds (e.g., a data asset risk threshold, a data asset role explosion threshold, and/or a data asset vulnerability threshold) to identify ineffective subsets or portions of the data access controls. In some embodiments, the method may include iteratively updating the data access controls, and applying the data access controls to various data access requests within the virtual computing environment to identify subsets of the data access controls that can be improved. If the metrics, or some combination thereof, are above a predetermined threshold, the access controls may be approved for use in a real-world computing environment/system. Additionally or alternatively, the method 1900 may include: updating and/or adjusting, by the one or more generative AI models, the data access controls; and simulating the data access environment to see how the one or more data access metrics improve and/or decrease. For example, one metric (e.g., the data asset role explosion threshold) may indicate that a particular subset of the data access controls associated with one or more security groups is inadequate, in response to an explosion of data access requests from various groups for certain files that are typically only accessed by an individual group. Further, the method 1900 may include updating and/or adjusting the particular subset of the data access controls. Additionally or alternatively, the method 1900 may include simulating the data access environment to determine whether the data access controls including the updated subset of controls are suitable for use in a real-world computing environment.

The computing environment in which the method 1800 and the method 1900 are executed may include various components, such as a server computing device hosting the generative AI models and a user computing device displaying one or more user interfaces for interacting with the server computing device. In some aspects, an example server device 102, equipped with powerful processors and large storage capacities, is responsible for executing the intensive computational tasks involved in, running the generative AI models, and generating data access controls for an organizational computer network. An example user device 104, such as a desktop computer or mobile computing device used by an administrator managing a network of computing devices/elements, provides an interface for configuring and/or otherwise interacting with the one or more generative AI models described herein, for example.

### Additional Considerations

This detailed description is to be construed as exemplary only and does not describe every possible embodiment, as describing every possible embodiment would be impractical, if not impossible. One may implement numerous alternate embodiments, using either current technology or technology developed after the filing date of this application.

Although the present disclosure sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims. Although the following text sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In exemplary embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules may provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The performance of certain of the operations may be distributed among the one or more processors, not only residing within a single machine, but deployed across a number of machines. In some example embodiments, the one or more processors or processor-implemented modules may be located in a single geographic location (e.g., within a business or home environment, an office environment, or a server farm). In other example embodiments, the one or more processors or processor-implemented modules may be distributed across a number of geographic locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

The patent claims at the end of this patent application are not intended to be construed under 35 U.S.C. § 112(f) unless traditional means-plus-function language is expressly recited, such as “means for” or “step for” language being explicitly recited in the claim(s).

What is claimed:

1. A computer-implemented method for artificial intelligence-based data access control, the method comprising:
obtaining, by one or more processors, information management data associated with a computing environment;
preprocessing, by the one or more processors, the information management data to generate (i) a set of user profiles corresponding to a plurality of users of the computing environment and (ii) data asset consumption profiles for the plurality of users;
generating, by the one or more processors, a set of access controls for the computing environment including a set of user data access entitlements by inputting the preprocessed information management data to one or more generative artificial intelligence (AI) models, wherein the one or more generative AI models are trained on user profiles labelled with corresponding user data access entitlements;
obtaining, by the one or more processors, a data access request from a user within the plurality of users;
identifying, by the one or more processors, a subset of the set of access controls including one or more user data access entitlements assigned to the user;
applying, by the one or more processors, the one or more user data access entitlements assigned to the user to the data access request to determine whether the data access request is valid or invalid; and
in response to determining the data access request is valid, providing, by the one or more processors, data access to the user.

2. The computer-implemented method of claim 1, wherein preprocessing the information management data comprises:
codifying, by the one or more processors, the information management data using one or more machine learning (ML) models; and
generating, by the one or more processors, the preprocessed information management data by inputting the codified information management data to a generative AI model.

3. The computer-implemented method of claim 2, wherein codifying the information management data comprises:
identifying, by the one or more processors, current user data access entitlements and data access behaviors included in the information management data using a first artificial neural network (ANN);
classifying, by the one or more processors, data asset risks, data asset role explosions, and data asset vulnerabilities by inputting the information management data to a second ANN; and
identifying, by the one or more processors, data asset classifications, data asset patterns, and data asset usage controls included in the information management data using a third ANN.

4. The computer-implemented method of claim 3, wherein generating the set of access controls comprises:
generating, by the one or more processors, data access patterns based on the data asset consumption profiles and the data access behaviors by inputting the preprocessed information management data to a first generative AI model; and
generating, by the one or more processors, the set of user data access entitlements by inputting the data access patterns to a second generative AI model,
wherein the set of user data access entitlements include: data access entitlements for individual users, and data access entitlements for one or more groups of users.

5. The computer-implemented method of claim 4, wherein the data access entitlements for the one or more groups of users include one or more security group data access entitlements.

6. The computer-implemented method of claim 2, wherein preprocessing the information management data further comprises:
identifying, by the one or more processors, current access control policies for the computing environment by inputting the information management data to the one or more ML models.

7. The computer-implemented method of claim 6, wherein generating the set of access controls further comprises:
generating, by the one or more processors, updated access control policies based on the current access control policies by inputting the preprocessed information management data to the one or more generative AI models; and
converting, by the one or more processors, the updated access control policies into the set of access controls by inputting the updated access control policies the one or more generative AI models.

8. The computer-implemented method of claim 1, wherein the information management data is obtained from one or more of: a people management platform, a network monitoring system, one or more data management tools, an incident management tool, a project management tool, a compliance information data source, one or more external applications, or one or more external information technology (IT) data sources.

9. The computer-implemented method of claim 8, wherein the one or more data management tools include one or more of: a data management policy tool, a data security posture management tool, or a comprehensive data management tool.

10. The computer-implemented method of claim 8, wherein the preprocessed information management data includes one or more of: data asset consumption profiles, data user profiles, user login and asset usage patterns, access control policies, risk and vulnerability data, incident data, project data, data privacy mandates, application information, or external information.

11. The computer-implemented method of claim 1, wherein the data access request is valid in a first instance, and further comprising:
in a second instance:
in response to determining the data access request is invalid, denying, by the one or more processors, data access for the user.

12. The computer-implemented method of claim 11, further comprising:
generating, by the one or more processors, an explanation for why the data access request is invalid by inputting the one or more user data access entitlements assigned to the user and the data access request to the one or more generative AI models; and
providing, by the one or more processors, the explanation for presentation to the user.

13. The computer-implemented method of claim 1, wherein generating the set of access controls includes:
generating, by the one or more processors, a set of enforcement policies including a requirement that data accessible by the plurality of users of the computing environment is encrypted using quantum-resistant encryption.

14. The computer-implemented method of claim 1, wherein the plurality of users include one or both of: one or more users, or one or more computing users.

15. A computing system for artificial intelligence-based data access control, the system comprising:
one or more processors; and
one or more non-transitory memories, the one or more non-transitory memories having stored thereon computer-executable instructions that, when executed by the one or more processors, cause the one or more processors to:
obtain information management data associated with a computing environment;
preprocess the information management data to generate (i) a set of user profiles corresponding to a plurality of users of the computing environment and (ii) data asset consumption profiles for the plurality of users;
generate a set of access controls for the computing environment including a set of user data access entitlements by inputting the preprocessed information management data to one or more generative artificial intelligence (AI) models, wherein the one or more generative AI models are trained on user profiles labelled with corresponding user data access entitlements;
obtain a data access request from a user within the plurality of users;
identify a subset of the set of access controls including one or more user data access entitlements assigned to the user;
apply the one or more user data access entitlements assigned to the user to the data access request to determine whether the data access request is valid or invalid; and
in response to determining the data access request is valid, provide data access to the user.

16. The computing system of claim 15, the one or more non-transitory memories having stored thereon computer executable instructions that, when executed by the one or more processors, preprocess the information management data by causing the one or more processors to:
codify the information management data using one or more machine learning (ML) models; and
generate the preprocessed information management data by inputting the codified information management data to a generative AI model.

17. The computing system of claim 16, the one or more non-transitory memories having stored thereon computer executable instructions that, when executed by the one or more processors, codify the information management data by causing the one or more processors to:
identify current user data access entitlements and data access behaviors included in the information management data using a first artificial neural network (ANN);
classify data asset risks, data asset role explosions, and data asset vulnerabilities by inputting the information management data to a second ANN; and
identify data asset classifications, data asset patterns, and data asset usage controls included in the information management data using a third ANN.

18. The computing system of claim 17, the one or more non-transitory memories having stored thereon computer executable instructions that, when executed by the one or more processors, generate the set of access controls by causing the one or more processors to:
generate data access patterns based on the data asset consumption profiles and the data access behaviors by inputting the preprocessed information management data to a first generative AI model; and
generate the set of user data access entitlements by inputting the data access patterns to a second generative AI model,
wherein the set of user data access entitlements include: data access entitlements for individual users, and data access entitlements for one or more groups of users.

19. The computing system of claim 15, wherein the information management data is obtained from one or more of: a people management platform, a network monitoring system, one or more data management tools, an incident management tool, a project management tool, a compliance information data source, one or more external applications, or one or more external information technology (IT) data sources.

20. The computing system of claim 15, wherein the data access request is valid in a first instance, and the one or more non-transitory memories having stored thereon computer executable instructions that, when executed by the one or more processors, cause the one or more processors to:
in a second instance and in response to determining the data access request is invalid, deny data access for the user.
